(19) United States
(12) Patent Application Publication
(10) Pub. No.: US 2026/0268639 A1
(43) Pub. Date: Sep. 10, 2026

(54) IMAGE RECOGNITION METHOD AND APPARATUS, AND STORAGE MEDIUM AND ELECTRONIC DEVICE

(71) Applicant: TENCENT TECHNOLOGY (SHENZHEN) COMPANY LIMITED, Shenzhen (CN)

(72) Inventors: Sichen CHEN, Shenzhen (CN); Yingyi ZHANG, Shenzhen (CN); Siming HUANG, Shenzhen (CN); Ruixin ZHANG, Shenzhen (CN); Shouhong DING, Shenzhen (CN)

(73) Assignee: TENCENT TECHNOLOGY (SHENZHEN) COMPANY LIMITED, Shenzhen (CN)

(21) Appl. No.: 19/660,386

(22) Filed: Apr. 28, 2026

Related U.S. Application Data
(63) Continuation of application No. PCT/CN2025/081171, filed on Mar. 7, 2025.

(30) Foreign Application Priority Data
Apr. 8, 2024 (CN) 202410413600.4

(51) Int. Cl. G06V 10/77; G06V 10/25; G06V 10/75; G06V 10/774; G06V 10/82; G06V 40/10

(52) U.S. Cl. CPC G06V 10/7715; G06V 10/25; G06V 10/751; G06V 10/774; G06V 10/82; G06V 40/10

(57) ABSTRACT

An image recognition method, apparatus, and computer-readable storage medium for key point localization through iterative feature refinement. The method extracts image features from an image displaying an object to be recognized, then performs feature processing via a trained feature processing network on these features and initialized reference key point features to obtain final key point features. Key point positions are determined based on these final features. The feature processing network is trained through N cycles of processing, where each cycle refines sample feature pairs and adjusts network parameters based on feature differences until convergence. This iterative refinement approach enables accurate key point detection by progressively improving feature representations through cyclic processing of image and reference features.

### CROSS-REFERENCE TO RELATED APPLICATIONS

This application is a continuation application of International Application No. PCT/CN2025/081171 filed on Mar. 7, 2025 which claims priority to Chinese Patent Application No. 202410413600.4, filed with the China National Intellectual Property Administration on Apr. 8, 2024, the disclosures of each being incorporated by reference herein in their entireties.

### FIELD

The disclosure relates to the field of computers, and an image recognition technique.

### BACKGROUND

In the related art, an image generally may be recognized to determine positions of key points in an object to be recognized in the image, and then, the positions of the key points in the object to be recognized are further analyzed to complete the vision tasks based on a result of the analysis.

For recognition and positioning of the key points in the image, a manner usually used in current related art is extracting image features by using a deep network feature extractor manually designed in advance and then recognizing the key points of an object in the image by using the image features.

However, in the manner provided in the related art, a large number of parameters are involved in a deep network, and the calculation complexity is high, so a large amount of time is generally needed for training. That is, a process of performing image recognition by using the deep convolutional network may consume a large amount of time, and may thus result in a technical problem of low image recognition efficiency.

### SUMMARY

Provided are an image recognition method and apparatus, a device, a storage medium, and a program product, which can implement accurate key point localization through iterative feature processing using cyclic feature refinement networks trained with convergence-based parameter optimization.

According to some embodiments, an image recognition method, performed by an electronic device, includes: extracting image features from an image to be recognized, the image to be recognized displaying an object to be recognized; performing, via a feature processing network, feature processing on the image features and reference key point features obtained through initialization to obtain final key point features of the object to be recognized, the final key point features indicating features of key points of the object to be recognized in the image to be recognized; and determining positions of the key points of the object to be recognized in the image to be recognized based on the final key point features, wherein the feature processing network is obtained by performing N cycles of feature processing on each sample image using an initialized feature processing network, wherein an i^{th} cycle of feature processing comprises: performing, via an i^{th} feature processing network, feature processing on an (i−1)^{th} sample feature pair obtained from an (i−1)^{th} cycle of feature processing to obtain an i^{th} sample feature pair; and adjusting network parameters of the i^{th} feature processing network based on feature differences between the (i−1)^{th} sample feature pair and the i^{th} sample feature pair until a convergence condition is reached, wherein i is an integer from 1 to N, and N is a positive integer, wherein the i^{th} sample feature pair comprises i^{th} sample image features and i^{th} reference sample key point features, wherein the i^{th} sample image features are obtained by performing i cycles of feature processing on original sample image features extracted from the sample images, and wherein the i^{th} reference sample key point features are obtained by performing i cycles of feature processing on original reference sample key point features obtained through initialization.

According to some embodiments, an image recognition apparatus, includes: at least one memory configured to store program code; and at least one processor configured to read the program code and operate as instructed by the program code, the program code including: extraction code configured to cause at least one of the at least one processor to extract image features from an image to be recognized, the image to be recognized displaying an object to be recognized; processing code configured to cause at least one of the at least one processor to perform, via a feature processing network, feature processing on the image features and reference key point features obtained through initialization to obtain final key point features of the object to be recognized, the final key point features indicating features of key points of the object to be recognized in the image to be recognized; and determination code configured to cause at least one of the at least one processor to determine positions of the key points of the object to be recognized in the image to be recognized based on the final key point features.

According to some embodiments, a non-transitory computer-readable storage medium, storing computer code which, when executed by at least one processor, causes the at least one processor to at least: extract image features from an image to be recognized, the image to be recognized displaying an object to be recognized; perform, via a feature processing network, feature processing on the image features and reference key point features obtained through initialization to obtain final key point features of the object to be recognized, the final key point features indicating features of key points of the object to be recognized in the image to be recognized; and determine positions of the key points of the object to be recognized in the image to be recognized based on the final key point features.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application environment of an image recognition method according to some embodiments.

FIG. 2 is a schematic flowchart of an image recognition method according to some embodiments.

FIG. 3 is a schematic flowchart of an image recognition method according to some embodiments.

FIG. 4 is a schematic flowchart of an image recognition method according to some embodiments.

FIG. 5 is a schematic diagram of an image recognition method according to some embodiments.

FIG. 6 is a schematic flowchart of an image recognition method according to some embodiments.

FIG. 7 is a schematic flowchart of an image recognition method according to some embodiments.

FIG. 8 is a schematic structural diagram of an image recognition apparatus according to some embodiments.

FIG. 9 is a schematic structural diagram of an image recognition preprocessing apparatus according to some embodiments.

FIG. 10 is a schematic structural diagram of an electronic device according to some embodiments.

FIG. 11 is a schematic structural diagram of another electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In order to help those skilled in the art better understand the technical solutions of this application, the technical solutions in embodiments of this application are clearly and completely described hereafter with reference to the accompanying drawings in the embodiments of this application. Apparently, the described embodiments are merely some rather than all of the embodiments of this application. All other embodiments obtained by persons of ordinary skill in the art based on the embodiments of this application without creative efforts shall fall within the protection scope of this application.

In the specification, claims, and accompanying drawings of this application, the terms “first”, “second”, etc. are intended to distinguish similar objects, but do not necessarily indicate a order or sequence. Data used in such a way is interchangeable in a proper case, so that the embodiments of this application described herein may be implemented, for example, in a sequence other than the sequence illustrated or described herein. Moreover, the terms “include”, “have”, and any other variants thereof are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

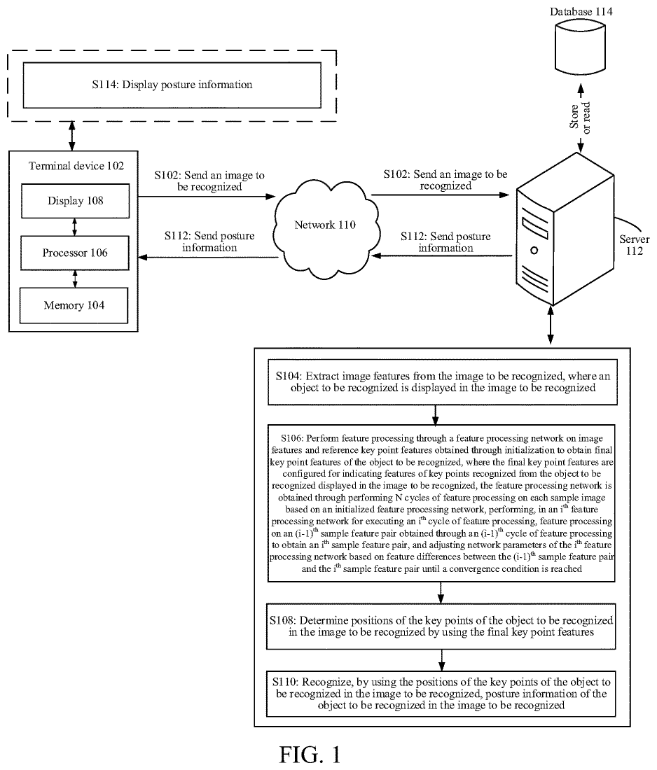

According to an aspect of embodiments of this application, an image recognition method is provided. As an exemplary implementation, the image recognition may be applied to but not limited to an environment shown in FIG. 1 in some embodiments. As shown in FIG. 1, a terminal device 102 includes a memory 104 configured to store data generated in an operation process of the terminal device 102, a processor 106 configured to process and compute the data, and a display 108 configured to display an image to be recognized. The terminal device 102 may perform data interaction with a server 112 over a network 110. The server 112 is connected to a database 114, and the database 114 is configured to store data. The terminal device 102 may run an application program configured to recognize the image to be recognized.

Further, a corresponding application process of the method in the environment shown in FIG. 1 is shown by the following operations:
S102: When obtaining an image to be recognized, the terminal device 102 sends the image to be recognized to the server 112 over the network 110.
S104: After receiving the image to be recognized, the server 112 extracts image features from the image to be recognized. An object to be recognized is displayed in the image to be recognized.
S106: The server 112 performs feature processing through a feature processing network on the image features and reference key point features obtained through initialization to obtain final key point features of the object to be recognized. The final key point features are configured for indicating features of key points recognized from the object to be recognized displayed in the image to be recognized. The feature processing network is obtained through performing N cycles of feature processing on each sample image based on an initialized feature processing network. In an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of the i^{th} feature processing network are adjusted based on feature differences between the (i−1)^{th} sample feature pair and the i^{th} sample feature pair until a convergence condition is reached, i is a positive integer greater than or equal to 1 and less than or equal to N, N is a positive integer. The i^{th} sample feature pair includes i^{th} sample image features and i^{th} reference sample key point features. The i^{th} sample image features are obtained through performing i cycles of feature processing based on original sample image features extracted from the sample images. The i^{th} reference sample key point features are obtained through performing i cycles of feature processing based on original reference sample key point features obtained through initialization.
S108: The server 112 determines, by using the final key point features, positions of the key points of the object to be recognized in the image to be recognized.
S110: The server 112 recognizes, by using the positions of the key points of the object to be recognized in the image to be recognized, posture information of the object to be recognized in the image to be recognized.
S112: The server 112 sends the posture information to the terminal device 102 over the network 110.
S114: The terminal device 102 displays the posture information when receiving the posture information.

In the embodiments of this application, image features are extracted from an image to be recognized. An object to be recognized is displayed in the image to be recognized. Then, feature processing is performed through a feature processing network on the image features and reference key point features obtained through initialization to obtain final key point features of the object to be recognized. The final key point features are configured for indicating features of key points recognized from the object to be recognized displayed in the image to be recognized. The feature processing network is obtained through performing N cycles of feature processing on each sample image based on an initialized feature processing network. In an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of the i^{th} feature processing network are adjusted based on feature differences between the (i−1)^{th} sample feature pair and the i^{th} sample feature pair until a convergence condition is reached, i is a positive integer greater than or equal to 1 and less than or equal to N, N is a positive integer. The i^{th} sample feature pair includes i^{th} sample image features and i^{th} reference sample key point features. The i^{th} sample image features are obtained through performing i cycles of feature processing based on original sample image features extracted from the sample images. The i^{th} reference sample key point features are obtained through performing i cycles of feature processing based on original reference sample key point features obtained through initialization. Then, positions of the key points of the object to be recognized in the image to be recognized are determined by using the final key point features. In other words, by using the embodiments of this application, the feature processing network obtained based on the multi-cycle self-distillation training is configured to locate the positions, in the image to be recognized, of the key points of the object to be recognized in the image to be recognized. The feature processing network obtained based on the multi-cycle self-distillation training is a lightweight network, and the network performance can be improved by using few parameters and low-complexity calculation, so the accuracy of network calculation results is ensured, and at the same time, the time consumed for network training is reduced. The technical problem of low image recognition efficiency in an image recognition means provided in the related art is further solved, and the technical effect of improving the image recognition efficiency is achieved.

In some embodiments, the terminal device may be a terminal device provided with a target client, and may include but is not limited to at least one of the followings: a mobile phone (such as an Android mobile phone or an iOS mobile phone), a notebook computer, a tablet computer, a palmtop computer, a mobile Internet device (MID), a PAD, a desktop computer, a smart television, etc. The target client may be a video client, an instant messaging client, a browser client, an education client, etc. The network may include but is not limited to a wired network and a wireless network. The wired network includes a local area network, a metropolitan area network, and a wide area network. The wireless network includes Bluetooth, WIFI, and other networks implementing wireless communication. The server may be a single server, and may also be a server cluster including a plurality of servers, or a cloud server. The above is merely an example, which is not limited in some embodiments.

In some embodiments, as an exemplary implementation, as shown in FIG. 2, the image recognition method includes the following operations:
S202: Image features are extracted from an image to be recognized. The object to be recognized is displayed in the image to be recognized.
S204: Feature processing is performed through a feature processing network on the image features and reference key point features obtained through initialization to obtain final key point features of the object to be recognized. The final key point features are configured for indicating features of key points recognized from the object to be recognized displayed in the image to be recognized. The feature processing network is obtained through performing N cycles of feature processing on each sample image based on an initialized feature processing network. In an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of the i^{th} feature processing network are adjusted based on feature differences between the (i−1)^{th} sample feature pair and the i^{th} sample feature pair until a convergence condition is reached, i is a positive integer greater than or equal to 1 and less than or equal to N, N is a positive integer. The i^{th} sample feature pair includes i^{th} sample image features and i^{th} reference sample key point features. The i^{th} sample image features are obtained through performing i cycles of feature processing based on original sample image features extracted from the sample images. The i^{th} reference sample key point features are obtained through performing i cycles of feature processing based on original reference sample key point features obtained through initialization.
S206: Positions of the key points of the object to be recognized in the image to be recognized are determined by using the final key point features.

In some embodiments, the image recognition method may be applied to but not limited to a processing scenario of a computer vision task, such as identity recognition and posture estimation. This is not limited in some embodiments. Specifically, in an identity recognition scenario, the positions of the key points (for example, points in a palmprint of the object to be recognized, points in a fingerprint of the object to be recognized, or points in a pupil of the object to be recognized) of the object to be recognized displayed in the image to be recognized can be recognized by using the image recognition method. Then, the key points are extracted from the image to be recognized by using the positions of the key points in the object to be recognized, so as to further recognize the identity of the object to be recognized by using the key points. For example, the identity of the object to be recognized is recognized through fingerprint detection, palmprint detection, pupil detection, human face detection, and the like. This is not limited in some embodiments. In a posture estimation scenario, the above image recognition method may be used, the positions of the key points (for example, points in a skeleton of the object to be recognized) of the object to be recognized displayed in the image to be recognized may be recognized. The posture of the object to be recognized may be further determined based on the positions. The posture may be used for further behavior analysis (for example, helping recognize actions and postures of humans or animals through posture estimation so as to realize analysis and understanding of behaviors), posture alignment and registration (for example, helping align and register other objects or humans of different postures by using the posture, so as to realize matching and identification of the objects or humans), posture generation and reconstruction (for example, generating and reconstructing a three-dimensional model by using the posture, so as to realize three-dimensional reconstruction and modeling of the objects or the humans), etc.

In some embodiments, the object to be recognized is an object needing key point recognition, and may be but not limited to be configured for indicating a person, an object, an animal, and the like. This is not limited in some embodiments. Further, if the object to be recognized is a person object, then the key points in the object to be recognized may be but not limited to be points for indicating a part of the object to be recognized, for example, points in a skeleton of the object to be recognized, points in a palmprint of the object to be recognized, points in a fingerprint of the object to be recognized, or points in a pupil of the object to be recognized. This is not limited in some embodiments, and depends on a scenario to which the method is applied.

The reference key point features may be a starting point of N cycles of feature processing. The final key point features are obtained through cyclic iterative optimization on the reference key point features. The reference key point features, as a starting point of N cycles of feature processing, provides a direction for N cycles of feature processing, so that correct key point features, i.e., the final key point features can be obtained through convergence as soon as possible.

An initialization manner is not limited in embodiments of this application. For example, it may be random initialization, or may be initialization based on prior knowledge, initialization based on a statistical model, initialization based on image features, etc.

The image features are visual features of the image to be recognized, and for example, may include an edge, a contour, a texture, etc. The image features can reflect a shape and a structure of the object to be recognized. By extracting and using these features, the key points of the object to be recognized can be more accurately located. After the reference key point features are obtained through initialization, the reference key point features are optimized by using visual image features, so the prediction accuracy and robustness can be further improved, and the accurate final key point features can be obtained.

Further, the image features may be but not limited to be configured for indicating image features directly extracted from the image to be recognized, or may be configured for indicating image features obtained through conversion processing on the image features after the image features are extracted from the image to be recognized. This is not limited in some embodiments. Specifically, the operation of extracting all image features from the image to be recognized and then performing conversion processing on all the image features to obtain the image features may include but is not limited to the following operations:
S1: Recognition processing is performed on the image to be recognized by using a region recognition network so as to determine a candidate region in which the object to be recognized is located in the image to be recognized. The region recognition network may use, but is not limited to, a common target detection neural network model, for example, a convolutional neural network (CNN), a You Only Look One (YOLO) neural network, or another neural network model having a similar function. This is not limited in some embodiments.
S2: The image to be recognized is cropped to reserve the candidate region in which the object to be recognized is located in the image to be recognized.
S3: Image features corresponding to an image content displayed in the candidate region are extracted by using a feature extraction network. The feature extraction network may be but not limited to be configured for indicating a common deep learning model, for example, a generative adversarial network (GAN), a pre-trained model, an autoencoder, a classic backbone network, or another neural network model having a similar function. This is not limited in some embodiments.
S4: A feature dimension of the image features is adjusted to a preset dimension to obtain adjusted image features. The dimension of the image features may be adjusted by using, but not limited to, a linear neural network model or another neural network model having a similar function. This is not limited in some embodiments.
S5: Position encoding processing is performed on the adjusted image features, and obtained image visual tokens are determined as the image features. The position encoding on the image features may be performed by using, but not limited to, a position embedding model or another neural network model having a similar function. This is not limited in some embodiments. Further, after the image features are extracted from the image to be recognized, the method may include, but is not limited to, inputting the image features and the reference key point features into the feature processing network. In some embodiments, the feature processing network may be but not limited to be configured for indicating a self-attention neural network model. Specifically, the self-attention neural network model may include, but not limited to, a plurality of self-attention sub-neural networks. Each of the plurality of self-attention sub-neural networks further includes a plurality of attention neural network layers.

In some embodiments, the operation that feature processing is performed on the image feature through the feature processing network to obtain the final key point features of the key points in the object to be recognized may include but not limited to performing the following operations in the feature processing network: obtained (j−1)^{th} image feature and (j−1)^{th} reference key point feature outputted by a (j−1)^{th} feature processing sub-network in the feature processing network are inputted to a j^{th} feature processing sub-network in the feature processing network, where the feature processing network includes P feature processing sub-networks, j is greater than 1 and less than or equal to P, and P is a positive integer; in the j^{th} feature processing sub-network, cycle feature processing is performed on the (j−1)^{th} image feature and the (j−1)^{th} reference key point feature to obtain a j^{th} image feature and a j^{th} reference key point feature; when j is equal to P, the j^{th} reference key point feature is determined as the final key point feature of the key points in the object to be recognized; and when j is less than P, the obtained j^{th} image feature and j^{th} reference key point feature are inputted into a (j+1)^{th} feature processing sub-network to perform a (j+1)^{th} cycle of feature processing.

In some embodiments, before the image features are extracted from the image to be recognized, the method may include but not limited to: performing N cycles of feature processing on each sample image based on an initialized feature processing network, performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, and adjusting network parameters of the i^{th} feature processing network based on feature differences between the (i−1)^{th} sample feature pair and the i^{th} sample feature pair until a convergence condition is reached, where i is greater than or equal to 1 and less than or equal to N, and N is a positive integer.

Further, the operation that positions of the key points of the object to be recognized in the image to be recognized are determined by using the final key point features may include but not limited to: performing mapping processing on the final key point features by using a fully-connected layer connected to the feature processing network so as to obtain positions of target key points in the image to be recognized. The fully-connected layer may be but is not limited to a network layer obtained through training alone or joint training with the feature processing network.

In some embodiments, if the image recognition method is applied to a posture detection scenario, the method may be completely illustrated and described by using but not limited to the following operations:
S1: Image features are extracted from an image to be recognized, and reference key point features are obtained in an initialization manner.
S2: The image features and the reference key point features are inputted into a feature processing network.
S3: Feature processing is performed through a feature processing network on the image features and reference key point features to obtain final key point features corresponding to key points of the object to be recognized. The final key point features are configured for indicating features of key points recognized from the object to be recognized displayed in the image to be recognized. The feature processing network is obtained through performing N cycles of feature processing on each sample image based on an initialized feature processing network. In an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of the i^{th} feature processing network are adjusted based on feature differences between the (i−1)^{th} sample feature pair and the i^{th} sample feature pair until a convergence condition is reached, i is a positive integer greater than or equal to 1 and less than or equal to N, N is a positive integer. The i^{th} sample feature pair includes i^{th} sample image features and i^{th} reference sample key point features. The i^{th} sample image features are obtained through performing i cycles of feature processing based on original sample image features extracted from the sample images. The i^{th} reference sample key point features are obtained through performing i cycles of feature processing based on original reference sample key point features obtained through initialization.
S4: Mapping processing is performed on the final key point features by using a fully-connected layer connected to the feature processing network so as to obtain positions of the key points of the object to be recognized in the image to be recognized.
S5: A posture of the object to be recognized is recognized by using the positions.

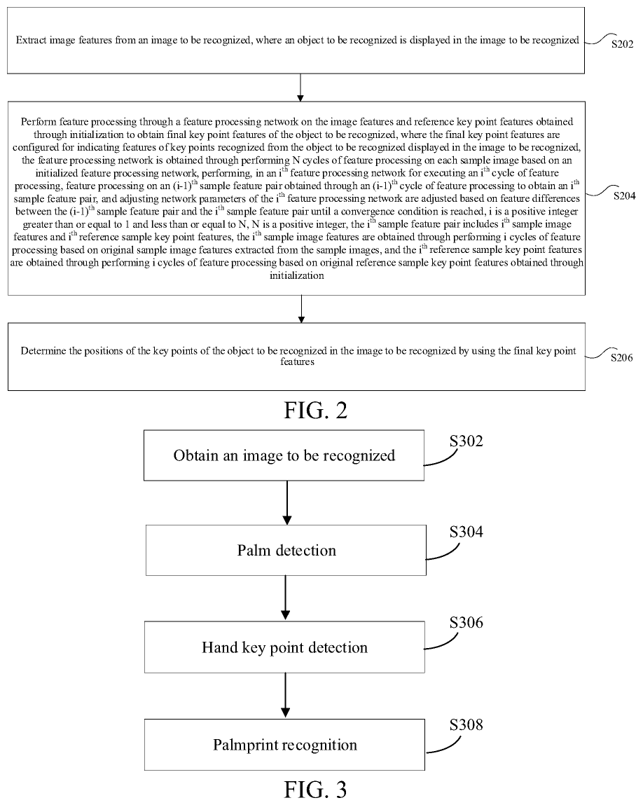

In another embodiment, if the image recognition method is applied to a palmprint-based identity detection scenario, the method may be completely illustrated and described by using but not limited to the following operations shown in FIG. 3:
S302: An image to be recognized is obtained. A palm of the object to be recognized is displayed in an image to be recognized.
S304: Palm detection is performed. Specifically, recognition processing is performed on the image to be recognized by using the region recognition network in a palm detection module so as to determine a candidate region in which the palm is located in the image to be recognized. Then, the image to be recognized is cropped to reserve the candidate region of the palm in the image to be recognized. Therefore, image features corresponding to an image content displayed in the candidate region extracted by using the feature extraction network are determined as the image features.
S306: Hand key point detection is performed. Specifically, the image features and reference key point features obtained through initialization are inputted into a feature processing network, and feature processing is performed on the image features and the reference key point features by using the feature processing network to obtain palm key point image features corresponding to key points in the palm. Then, mapping processing is performed on the palm key point image features by using a fully-connected layer connected to the feature processing network so as to obtain positions of the palm key points in the image to be recognized.
S308: Palmprint recognition is performed. Specifically, a palm image is extracted based on the positions of the palm key points in the image to be recognized, and then comparison analysis is performed on the palm image and palm images in a database to further recognize identity of the object to be recognized.

In the embodiments of this application, image features are extracted from an image to be recognized. An object to be recognized is displayed in the image to be recognized. Then, feature processing is performed through a feature processing network on the image features and reference key point features obtained through initialization to obtain final key point features of the object to be recognized. The final key point features are configured for indicating features of key points recognized from the object to be recognized displayed in the image to be recognized. The feature processing network is obtained through performing N cycles of feature processing on each sample image based on an initialized feature processing network. In an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of the i^{th} feature processing network are adjusted based on feature differences between the (i−1)^{th} sample feature pair and the i^{th} sample feature pair until a convergence condition is reached, i is a positive integer greater than or equal to 1 and less than or equal to N, N is a positive integer. The i^{th} sample feature pair includes i^{th} sample image features and i^{th} reference sample key point features. The i^{th} sample image features are obtained through performing i cycles of feature processing based on original sample image features extracted from the sample images. The i^{th} reference sample key point features are obtained through performing i cycles of feature processing based on original reference sample key point features obtained through initialization. Then, positions of the key points of the object to be recognized in the image to be recognized are determined by using the final key point features. In other words, by using the embodiments of this application, the feature processing network obtained based on multi-cycle self-distillation training is configured for locating the positions, in the image to be recognized, of the key points of the object to be recognized in the image to be recognized. The accuracy of network calculation results is ensured, and at the same time, the time consumed for network training is reduced. The technical problem of low image recognition efficiency in an image recognition means provided in the related art is further solved, and the technical effect of improving the image recognition efficiency is achieved.

In some embodiments, as an exemplary implementation, the operation that feature processing is performed through a feature processing network on the image features and reference key point features obtained through initialization to obtain final key point features of the object to be recognized includes:
performing the following operations in the feature processing network:
Obtained (j−1)^{th} image feature and (j−1)^{th} reference key point feature outputted by a (j−1)^{th} feature processing sub-network in the feature processing network are inputted to a j^{th} feature processing sub-network in the feature processing network. The feature processing network includes P feature processing sub-networks, j is greater than 1 and less than or equal to P, and P is a positive integer.

In the j^{th} feature processing sub-network, cycle feature processing is performed on the (j−1)^{th} image feature and the (j−1)^{th} reference key point feature to obtain a j^{th} image feature and a j^{th} reference key point feature.

When j is equal to P, the j^{th} reference key point feature is determined as the final key point feature.

When j is less than P, obtained j^{th} image feature and j^{th} reference key point feature are inputted into a (j+1)^{th} feature processing sub-network to perform a (j+1)^{th} cycle of feature processing.

In some embodiments, the feature processing network may be but not limited to be configured for indicating a self-attention neural network model. Specifically, the self-attention neural network model may include, but not limited to, a plurality of self-attention sub-neural networks. Each of the plurality of self-attention sub-neural networks further includes a plurality of attention neural network layers.

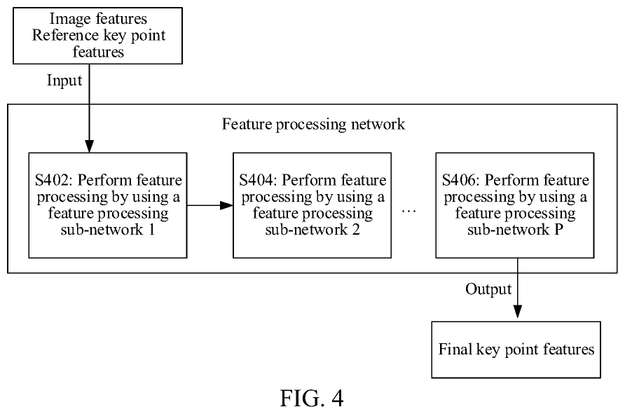

In some embodiments, by taking the feature processing network including P feature processing sub-networks which are respectively a feature processing sub-network 1, a feature processing sub-network 2, . . . , and a feature processing sub-network P as an example, the method may be illustrated and described by using an example based on but not limited to the following operations shown in FIG. 4:
S402 is executed. The image features and the reference key point features are inputted into the feature processing sub-network 1 in the feature processing network. Then, feature processing is performed on the image features and the reference key point features by using the feature processing sub-network 1 to obtain a first image feature and a first reference key point feature. The feature processing sub-network 1 is determined not to be the last feature processing sub-network. Then, S404 is executed. The first image feature and the first reference key point feature are inputted into the feature processing sub-network 2 in the feature processing network. Then, feature processing is performed on the first image feature and the first reference key point feature by using the feature processing sub-network 2 to obtain a second image feature and a second reference key point feature. The feature processing sub-network 2 is determined not to be the last feature processing sub-network. The process continues by inputting second image feature and the second reference key point feature to a next feature processing sub-network in the feature processing network for feature processing, and so on, until a (P−1)^{th} image feature and a (P−1)^{th} reference key point feature are obtained. Then, S406 is executed. The (P−1)^{th} image feature and the (P−1)^{th} reference key point feature are inputted to a feature processing sub-network P in the feature processing network. Then, feature processing is performed on the (P−1)^{th} image feature and the (P−1)^{th} reference key point feature by using the feature processing sub-network P to obtain a P^{th} image feature and a p^{th} reference key point feature. The feature processing sub-network P is determined to be the last feature processing sub-network, and the P reference key point feature is determined as the final key point feature.

The above example is only an example in some embodiments, and the above operations may also be implemented in another manner. This is not limited in some embodiments.

In the embodiments of this application, feature processing is performed on the image features by using the plurality of feature processing sub-networks included in the feature processing network obtained through multi-cycle self-distillation training to obtain the final key point features. This makes the obtained final key point features are more reliable. Therefore, the technical effect of improving image recognition accuracy is achieved.

In some embodiments, as an exemplary implementation, the operation that in the j^{th} feature processing sub-network, feature processing is performed on the (j−1)^{th} image feature and the (j−1)^{th} reference key point feature to obtain a j^{th} image feature and a j^{th} reference key point feature includes:
performing the following operations in the j^{th} feature processing sub-network:

In a first feature processing layer of the j^{th} feature processing sub-network, linear transformation processing is performed on an image sub-feature outputted by a (j−1)^{th} feature processing sub-network to obtain a first image sub-feature; and linear transformation processing is performed on a reference key point sub-feature outputted by the (j−1)^{th} feature processing sub-network to obtain a first reference key point sub-feature.

In an h^{th} feature processing layer of the j^{th} feature processing sub-network, an (h−1)^{th} image sub-feature and an (h−1)^{th} reference key point sub-feature outputted by an (h−1)^{th} feature processing layer of the j^{th} feature processing sub-network are inputted to the h^{th} feature processing layer in the j^{th} feature processing sub-network, and h is a positive integer greater than or equal to 2.

In the h^{th} feature processing layer, linear transformation processing is performed on the (h−1)^{th} image sub-feature to obtain a first processing result, and the first processing result is determined as an h^{th} image sub-feature outputted by the h^{th} feature processing layer; linear transformation processing is performed on the (h−1)^{th} reference key point sub-feature to obtain a second processing result; and an h^{th} reference key point sub-feature outputted by the h^{th} feature processing layer is obtained by using the first processing result and the second processing result.

When the h^{th} feature processing layer is the last feature processing layer in the j^{th} feature processing sub-network, the h^{th} image sub-feature is determined as a j^{th} image feature outputted by the j^{th} feature processing sub-network, and the h^{th} reference key point sub-feature is determined as a j^{th} reference key point feature outputted by the j^{th} feature processing sub-network.

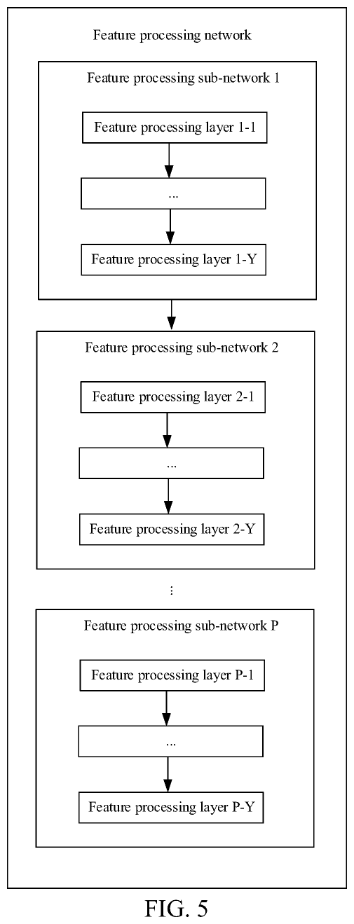

In some embodiments, as an exemplary implementation, taking the above-mentioned feature processing network as shown in FIG. 5 as an example, the feature processing network includes P feature processing sub-networks which are respectively a feature processing sub-network 1, a feature processing sub-network 2, . . . , and a feature processing sub-network P. Each of the feature processing sub-networks includes Y feature processing layers. The feature processing sub-network 1 includes a feature processing layer 1-1, a feature processing layer 1-2, . . . , and a feature processing layer 1-Y. The feature processing sub-network 2 includes a feature processing layer 2-1, a feature processing layer 2-2 . . . , and a feature processing layer 2-Y. The feature processing sub-network P includes a feature processing layer P-1, a feature processing layer P-2, . . . , and a feature processing layer P-Y. The above method is illustrated and described by using the following operations:
S502. The image features and the reference key point features are inputted to the feature processing layer 1-1 in the feature processing sub-network 1, and feature processing is performed on the image features and the reference key point features by using the feature processing layer 1-1 to obtain an image feature 1-1 and a reference key point feature 1-1.

The operation that feature processing is performed on the image features and the reference key point features by using the feature processing layer 1-1 to obtain an image feature 1-1 and a reference key point feature 1-1 may include but is not limited to: performing linear transformation processing on the image features to obtain a query vector, a key vector, and a value vector corresponding to the image features; performing linear transformation processing on the reference key point feature to obtain a query vector, a key vector, and a value vector corresponding to the reference key point features; and then, determining the image feature 1-1 by using the query vector, the key vector, and the value vector corresponding to the image features; and determining the reference key point feature 1-1 by using the query vector, the key vector, and the value vector corresponding to the reference key point feature.

For example, the implementation of determining the image feature 1-1 by using the query vector, the key vector, and the value vector corresponding to the image features, and determining the reference key point feature 1-1 by using the query vector, the key vector, and the value vector corresponding to the reference key point features may refer to but is not limited to the following examples:

$${s}_{a 1} = Attention ( {Q}_{s} , {K}_{s} , {V}_{s} ) = softmax ( \frac{{Q}_{s} {K}_{s}^{T}}{\sqrt{{d}_{ks}}} ) {V}_{s} ; and \qquad ( 1 )$$

$${g}_{a 1} = Attention ( {Q}_{g} , {K}_{g} , {V}_{g} ) = softmax ( \frac{{Q}_{g} {K}_{g}^{T}}{\sqrt{{d}_{kg}}} ) {V}_{s} . \qquad ( 2 )$$

In the formulas, Sₐ₁ represents the image feature 1-1, and gₐ₁ represents the reference key point feature 1-1, and the Qₛ, Kₛ, Vₛ respectively represent the query vector, the key vector, and the value vector corresponding to the image features, Q_{g}, K_{g}, V_{g} respectively represent the query vector, the key vector, and the value vector corresponding to the reference key point features, dₖₛ represents a dimension of Kₛ, and d_{kg} represents a dimension of K_{g}.
S504. The image feature 1-1 and the reference key point feature 1-1 are inputted to the feature processing layer 1-2 in the feature processing sub-network 1, and feature processing is performed on the image feature 1-1 and the reference key point feature 1-1 by using the feature processing layer 1-2 to obtain an image feature 1-2 and a reference key point feature 1-2.

The operation that feature processing is performed on the image feature 1-1 and the reference key point feature 1-1 by using the feature processing layer 1-2 to obtain an image feature 1-2 and a reference key point feature 1-2 may include but is not limited to: performing linear transformation processing on the image feature 1-1 to obtain an image feature 1-2; performing linear transformation processing on the reference key point feature 1-1 to obtain a query vector, a key vector corresponding to the reference key point feature 1-1; and then, determining the reference key point feature 1-2 by using the image feature 1-2 and the query vector and the key vector corresponding to the reference key point feature 1-1.

For example, the implementation of determining the reference key point feature 1-2 by using the image feature 1-2 and the query vector and the key vector corresponding to the reference key point feature 1-1 may refer to but not limited to the following example:

$${g}_{a 2} = Attention ( {Q}_{g 1} , {K}_{g 1} , {V}_{g 1} ) = softmax ( \frac{{Q}_{g 1} {K}_{g 1}^{T}}{\sqrt{{d}_{kg 1}}} ) {s}_{a 2} . \qquad ( 3 )$$

In the formula, gₐ₂ represents the reference key point feature 1-2, and Q_{g1}, K_{g1} respectively represent the query vector and the key vector corresponding to the reference key point feature 1-1, Sₐ₂ represents the image feature 1-2 obtained by performing linear transformation processing on the image feature 1-1, and d_{kg1} represents a dimension of K_{g1}.

And so on, until an image feature 1-Y and a reference key point feature 1-Y outputted by using the feature processing layer 1-Y are obtained.
S506: The image feature 1-Y and the reference key point feature 1-Y are inputted to the feature processing layer 2-1 in the feature processing sub-network 2, and feature processing is performed on the image feature 1-Y and the reference key point feature 1-Y by using the feature processing layer 2-1 to obtain an image feature 2-1 and the reference key point feature 2-1. For a implementation, refer to an example in the feature processing layer 1-1. Details are not described in some embodiments again.
S508: The image feature 2-1 and the reference key point feature 2-1 are inputted into the feature processing layer 2-2 in the feature processing sub-network 2, and feature processing is performed on the image feature 2-1 and the reference key point feature 2-1 by using the feature processing layer 2-2 to obtain the image feature 2-2 and the reference key point feature 2-2. For a embodiment, refer to an example in the feature processing layer 1-2.

And so on, until an image feature 2-Y and a reference key point feature 2-Y outputted by using the feature processing layer 2-Y are obtained. Further, the image feature 2-Y and the reference key point feature 2-Y are inputted into a next feature processing sub-network until an image feature P-Y and a reference key point feature P-Y outputted by using the feature processing layer P-Y are obtained.
S510: The feature processing layer P-Y is determined as the last feature processing layer in the last feature processing sub-network in the feature processing network, and then the reference key point feature P-Y is determined as the final key point feature.

In the embodiments of this application, the final key point features of the object to be recognized are obtained by performing feature processing on the image features by using the plurality of feature processing layers respectively included in the plurality of feature processing sub-networks. This makes the obtained final key point features are more reliable. Therefore, the technical effect of improving image recognition accuracy is achieved.

In some embodiments, as an exemplary implementation, before the image features are extracted from the image to be recognized, the method further includes:
training the initialized feature processing network through the following operations:
extracting original sample image features from an obtained k^{th} sample image, and obtaining original reference sample key point features obtained through initialization, k being a positive integer greater than or equal to 1 and less than or equal to M, and M being a positive integer; and
repeatedly performing the following operations on the original sample image features and the original reference sample key point features until N cycles of feature processing are performed:
performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, the (i−1)^{th} sample feature pair obtained through the (i−1)^{th} cycle of feature processing being configured for indicating the original sample feature pair when i is 1, and the original sample feature pair comprising the original sample image features and the original reference sample key point features;
determining a sample feature distance between the (i−1)^{th} sample feature pair and the i^{th} sample feature pair based on the feature difference between the (i−1)^{th} sample feature pair and the i^{th} sample feature pair;
performing weighted summation calculation on the first i sample feature distances to obtain an i^{th} feature training loss;
adjusting, when the feature training loss determined based on all the sample feature distances obtained after the first i cycles of feature processing does not reach a threshold condition, network parameters of the i^{th} feature processing network to obtain an (i+1)^{th} feature processing network; performing the (i+1)^{th} cycle of feature processing in the (i+1)^{th} feature processing network; and
determining, when the feature training loss determined based on all the sample feature distances obtained after the first i cycles of feature processing reaches the threshold condition, the i^{th} cycle of feature processing as the N^{th} cycle of feature processing.

In some embodiments, N may be but not limited to be configured for indicating a preset target threshold corresponding to the maximum number of times each sample image is used to train the feature processing network, or may further be configured for indicating the number of times of training when the convergence condition is reached by training with a sample image feature processing network. The number of times of training when the convergence condition is reached is less than or equal to the target threshold. For example, if there are M sample images, each sample image is used for training up to x times, and if, when the feature processing network is trained by using a second sample image, the feature processing network still does not reach the convergence condition even after training for an x^{th} time, then an x^{th} cycle of feature processing performed in an x^{th} feature processing network may be determined as the N^{th} cycle of feature processing corresponding to the second sample image. If, when the feature processing network is trained by using a third sample image, the feature processing network reaches the convergence condition (i.e., the feature training loss reaches the threshold condition) after training for the second time, then the second cycle of feature processing performed in a second feature processing network may be determined as the N^{th} cycle of feature processing corresponding to the second sample image.

In some embodiments, after the adjusting, when the feature training loss determined based on all the sample feature distances obtained after the first i cycles of feature processing does not reach a threshold condition, network parameters of the i^{th} feature processing network to obtain an (i+1)^{th} feature processing network, determining whether i is equal to the target threshold or not is further included. i is a positive integer, and i is greater than 1.

Further, the performing the (i+1)^{th} cycle of feature processing in the (i+1)^{th} feature processing network may include but is not limited to: when the i is determined to be less than the target threshold, performing the (i+1)^{th} cycle of feature processing in the (i+1)^{th} feature processing network. In some embodiments, after the determining whether i is equal to the target threshold or not, determining the i^{th} cycle of feature processing as the N^{th} cycle of feature processing when the i is determined to be equal to the target threshold is further included.

In some embodiments, after the determining, when the feature training loss determined based on all the sample feature distances obtained after the first i cycles of feature processing reaches the threshold condition, the i^{th} cycle of feature processing as the N^{th} cycle of feature processing, the method further includes: determining the i^{th} feature processing network as the feature processing network that has reached the convergence condition.

In some embodiments, for a implementation of extracting the original sample image features from the obtained k^{th} sample image, refer to but not limited to the related example of obtaining the image features based on the image to be recognized above. This is not limited in some embodiments. In some embodiments, M may be but not limited to be configured for indicating a total number of the sample images.

In some embodiments, the determining a sample feature distance between the (i−1)^{th} sample feature pair and the i^{th} sample feature pair based on feature differences between the (i−1)^{th} sample feature pair and the i^{th} sample feature pair includes: calculating a distance between an (i−1)^{th} sample image feature in the (i−1)^{th} sample feature pair and an i^{th} sample image feature in the i^{th} sample feature pair to obtain an (i−1)^{th} sample image feature distance; and calculating a distance between an (i−1)^{th} reference sample key point feature in the (i−1)^{th} sample feature pair and an i^{th} reference sample key point feature in the i^{th} sample feature pair to obtain an (i−1)^{th} reference sample key point feature distance.

Further, the performing weighted summation calculation on the first i sample feature distances to obtain an i^{th} feature training loss includes: performing weighted summation calculation on the first i sample image feature distances to obtain a feature training loss, and performing weighted summation calculation on the first i reference sample key point feature distances to obtain a reference key point feature training loss; and performing weighted summation calculation on the feature training loss and the reference key point feature training loss to obtain the i^{th} feature training loss.

In some embodiments, as an exemplary implementation, the method may be illustrated and described by using but not limited to the following operations:

Original sample image features are extracted from the obtained k^{th} sample image. Then, the original sample image features and the original reference sample key point features obtained through initialization are inputted into the initialized feature processing network, and the first cycle of feature processing is performed on the original sample image features and the original reference sample key point features by using the initialized feature processing network to obtain the first sample image feature and the first reference sample key point feature.

Further, the first sample image feature distance between the first sample image feature and the original sample image feature is obtained, and the first reference sample key point feature distance between the first reference sample key point feature and the original reference sample key point feature is obtained. Further, the first sample feature distance is obtained based on the first sample image feature distance and the first reference sample key point feature distance. Therefore, when the feature training loss determined based on the first sample feature distances (i.e., all the sample feature distances obtained after the previous cycle of feature processing) reaches the threshold condition, the first cycle of feature processing is determined as the N^{th} cycle of feature processing.

When the feature training loss determined based on the first sample feature distance does not reach the threshold condition, network parameters of the initialized feature processing network are adjusted to obtain a second feature processing network. Then, the first sample image feature and the first reference sample key point feature are inputted into the second feature processing network, and cyclic feature processing is performed on the first sample image feature and the first reference sample key point feature by using the second feature processing network to obtain a second sample image feature and a second reference sample key point feature. Further, a second sample image feature distance between the first sample image feature and the second sample image feature is obtained, and a second reference sample key point feature distance between the first reference sample key point feature and the second reference sample key point feature is obtained. Further, weighted summation is performed on the first sample image feature distance and the second sample image feature distance to obtain a first summation result, and weighted summation is performed on the first reference sample key point feature distance and the second reference sample key point feature distance to obtain a second summation result. Further, weighted summation is performed on the first summation result and the second summation result to obtain a second sample feature distance.

Therefore, when the feature training loss determined based on the second sample feature distance reaches the threshold condition, the second cycle of feature processing is determined to be the N^{th} cycle of feature processing. When the feature training loss determined based on the second sample feature distance does not reach the threshold condition, network parameters of the second feature processing network are adjusted to obtain a third feature processing network. Next, the second sample image feature and the second reference sample key point feature are inputted to the third feature processing network, and with the reference to the operations performed in the second feature processing network, training and adjustment are continuously performed on the feature processing network until the feature processing network reaches the convergence condition (i.e., the training loss reaches the threshold condition), or until the number of cycles of feature processing reaches the target threshold. Details are not described in some embodiments again.

In the embodiments of this application, the initialized feature processing network is trained based on a multi-cycle self-distillation manner so as to obtain an available feature processing network manner. The accuracy of network calculation results is ensured, and at the same time, the time consumed for network training is reduced. In a self-cyclic iterative training process of the feature processing network, new sample data is continuously generated (i.e., the sample image features and the reference sample key point features obtained after each cycle of feature processing may be used as new sample data), so that the resource loss in the training process can be greatly reduced. Therefore, the technical problem of low image recognition efficiency in an image recognition means provided in the related art is solved, and the technical effect of improving the image recognition efficiency is achieved.

In some embodiments, as an exemplary implementation, the determining a sample feature distance between the (i−1)^{th} sample feature pair and the i^{th} sample feature pair is determined based on feature differences between the (i−1)^{th} sample feature pair and the i^{th} sample feature pair includes:
a distance between the (i−1)^{th} sample image feature in the (i−1)^{th} sample feature pair and the i^{th} sample image feature in the i^{th} sample feature pair is calculated to obtain the (i−1)^{th} sample image feature distance.

In some embodiments, the implementation of the operation may refer to but is not limited to the following example:

$${ℒ}_{vi - 1} = MSE ( {VT}_{i - 1} , {VT}_{i} ) . \qquad ( 5 )$$

In the formula, [symbol] represents the (i−1)^{th} sample image feature distance, VTᵢ₋₁ represents the (i−1)^{th} sample image feature, and VTᵢ represents the i^{th} sample image feature.

A distance between the (i−1)^{th} reference sample key point feature in the (i−1)^{th} sample feature pair and the i^{th} reference sample key point feature in the i^{th} sample feature pair is calculated to obtain the (i−1)^{th} reference sample key point feature distance.

In some embodiments, the implementation of the operation may refer to but is not limited to the following example:

$${ℒ}_{ki - 1} = MSE ( {KT}_{i - 1} , {KT}_{i} ) . \qquad ( 6 )$$

In the formula, [symbol] represents the (i−1)^{th} reference sample key point feature distance, KTᵢ₋₁ represents the (i−1)^{th} reference sample key point feature, and KTᵢ represents the i^{th} reference sample key point feature.

The above example indicates an exemplary example of the above operation. In some embodiments, the operation may also be implemented in another manner. This is not limited in some embodiments.

In the embodiments of this application, by obtaining a distance between sample image features outputted by every two adjacent feature processing network, obtaining a distance between reference sample key point features outputted by every two adjacent feature processing networks, and further determining the feature training loss value for training the feature processing network by using the distance of the sample image features and the distance of the reference sample key point features, an objective of self-distillation cyclic training of the feature processing network is achieved, so that the time consumed for network training is reduced. The technical problem of low image recognition efficiency in an image recognition means provided in the related art is further solved, and the technical effect of improving the image recognition efficiency is achieved.

In some embodiments, as an exemplary implementation, the performing weighted summation calculation on the first i sample feature distances to obtain an i^{th} feature training loss includes:
performing weighted summation calculation on the first i sample image feature distances to obtain a sample image feature training loss, and performing weighted summation calculation on the first i reference sample key point feature distances to obtain a reference key point feature training loss; and
performing weighted summation calculation on the sample image feature training loss and the reference key point feature training loss to obtain the i^{th} feature training loss.

In some embodiments, the implementation of the operation may refer to but is not limited to the following example:

$${ℒ}_{kt} = {\sum }_{x = 2}^{i} MSE ( {KT}_{x - 1} , {KT}_{x} ) , \qquad ( 7 )$$

$${ℒ}_{vt} = {\sum }_{x = 2}^{i} MSE ( {VT}_{x - 1} , {VT}_{x} ) , and \qquad ( 8 )$$

$$ℒ = {α}_{1} {ℒ}_{kt} + {α}_{2} {ℒ}_{vt} . \qquad ( 9 )$$

In the formula, VTₓ₋₁ represents an (x−1)^{th} sample image feature, VTₓ represents an x^{th} sample image feature, KTₓ₋₁ represents an (x−1)^{th} reference sample key point feature, KTₓ represents an x^{th} reference sample key point feature, [symbol] represents the sample image feature training loss, [symbol] represents the reference key point feature training loss, [symbol] represents the i^{th} feature training loss, α₂ and α₁ respectively represent respective weights corresponding to the sample image feature training loss and the reference key point feature training loss.

The above example indicates an exemplary example of the above operation. In some embodiments, the operation may also be implemented in another manner. This is not limited in some embodiments.

In the embodiments of this application, by obtaining a distance between sample image features outputted by every two adjacent feature processing network, obtaining a distance between reference sample key point features outputted by every two adjacent feature processing networks, and further determining the feature training loss value for training the feature processing network by using the distance of the sample image features and the distance of the reference sample key point features, an objective of self-distillation cyclic training of the feature processing network is achieved, so that the time consumed for network training is reduced. The technical problem of low image recognition efficiency in an image recognition means provided in the related art is further solved, and the technical effect of improving the image recognition efficiency is achieved.

In some embodiments, as an exemplary implementation, after the sample feature distance between the (i−1)^{th} sample feature pair and the i^{th} sample feature pair is determined based on feature differences between the (i−1)^{th} sample feature pair and the i^{th} sample feature pair, the method further includes:
inputting the i^{th} reference sample key point feature in the i^{th} sample feature pair to an i^{th} fully-connected layer to obtain an i^{th} key point prediction position;
comparing the i^{th} key point prediction position with a key point mark position in the k^{th} sample image to obtain an i^{th} key point prediction difference distance;
performing weighted summation calculation on the first i key point prediction difference distances to obtain an i^{th} key point prediction training loss;
performing weighted summation calculation on the i^{th} feature training loss and the i^{th} key point prediction training loss to obtain an i^{th} target loss;
adjusting, when the i^{th} target loss does not reach a threshold condition, network parameters in the i^{th} feature processing network and the i^{th} fully-connected layer to obtain the (i+1)^{th} feature processing network and an (i+1)^{th} fully-connected layer; performing a (i+1)^{th} cycle of feature processing in an (i+1)^{th} feature processing network, and obtaining an (i+1)^{th} key point prediction position in the (i+1)^{th} fully-connected layer; and
determining, when the i^{th} target loss reaches the threshold condition, the i^{th} cycle of feature processing as the N^{th} cycle of feature processing.

In some embodiments, the implementation that the i^{th} key point prediction position is compared with a key point mark position in the k^{th} sample image to obtain an i^{th} key point prediction difference distance may refer to but is not limited to the following example:

$${ℒ}_{pi} = MSE ( {pred}_{i} , GT ) . \qquad ( 10 )$$

In the formula, [symbol] represents the i^{th} key point prediction difference distance, predᵢ represents the i^{th} key point prediction position, and GT represents the key point mark position.

Further, in some embodiments, the implementation that weighted summation calculation is performed on the first i key point prediction difference distances to obtain an i^{th} key point prediction training loss may refer to but is not limited to the following example:

$${ℒ}_{pose} = {\sum }_{x = 1}^{i} MSE ( {pred}_{x} , GT ) . \qquad ( 11 )$$

In the formula, predₓ represents an x^{th} key point prediction position, GT represents the key point mark position, and [symbol] represents the i^{th} key point prediction training loss.

Further, in some embodiments, the implementation that weighted summation calculation is performed on the i^{th} feature training loss and the i^{th} key point prediction training loss to obtain an i^{th} target loss may refer to but is not limited to the following example:

$$ℒ = {ℒ}_{pose} + {α}_{1} {ℒ}_{kt} + {α}_{2} {ℒ}_{vt} . \qquad ( 12 )$$

In the formula, [symbol] represents the key point prediction training loss, [symbol] represents the sample image feature training loss, [symbol] represents the reference key point feature training loss, and [symbol] represents the target loss.

The above example indicates an exemplary example of the above operation. In some embodiments, the operation may also be implemented in another manner. This is not limited in some embodiments.

In the embodiments of this application, the initialized feature processing network and the fully-connected layer connected to the feature processing network are jointly trained based on a multi-cycle self-distillation manner so as to obtain an available feature processing network and fully-connected layer manner. The accuracy of network calculation results is ensured, and at the same time, the time consumed for network training is reduced. In a self-cyclic iterative training process of the feature processing network, new sample data is continuously generated (i.e., the sample image features and the reference sample key point features obtained after each cycle of feature processing may be used as new sample data), so that the resource loss in the training process can be greatly reduced. Therefore, the technical problem of low image recognition efficiency in an image recognition means provided in the related art is solved, and the technical effect of improving the image recognition efficiency is achieved.

In some embodiments, as an exemplary implementation, as an exemplary implementation, the image recognition preprocessing method includes:
obtaining M sample images and an initialized feature processing network, and performing training through the following operations:
extracting original sample image features from an obtained k^{th} sample image, and obtaining original reference sample key point features obtained through initialization, k being a positive integer greater than or equal to 1 and less than or equal to M, and M being a positive integer; and repeatedly performing the following operations on the original sample image
features and the original reference sample key point features until N cycles of feature processing are performed:
performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, the (i−1)^{th} sample feature pair obtained through the (i−1)^{th} cycle of feature processing being configured for indicating the original sample feature pair when i is 1, and the original sample feature pair comprising the original sample image features and the original reference sample key point features;
determining a sample feature distance between the (i−1)^{th} sample feature pair and the i^{th} sample feature pair based on the feature difference between the (i−1)^{th} sample feature pair and the i^{th} sample feature pair;
performing weighted summation calculation on the first i sample feature distances to obtain an i^{th} feature training loss; adjusting, when the feature training loss determined based on all the sample feature distances obtained after the first i cycles of feature processing does not reach the threshold condition, network parameters of the i^{th} feature processing network to obtain the (i+1)^{th} feature processing network;
the (i+1)^{th} cycle of feature processing is performed in the (i+1)^{th} feature processing network; and
determining, when the feature training loss determined based on all the sample feature distances obtained after the first i cycles of feature processing reaches the threshold condition, the i^{th} cycle of feature processing as the N^{th} cycle of feature processing.

In some embodiments, N may be but not limited to be configured for indicating a preset target threshold corresponding to the maximum number of times each sample image is used to train the feature processing network, or may further be configured for indicating the number of times of training when the convergence condition is reached by training with a sample image feature processing network. The number of times of training when the convergence condition is reached is less than or equal to the target threshold. For example, if there are M sample images, each sample image is used for training up to x times, and if, when the feature processing network is trained by using a second sample image, the feature processing network still does not reach the convergence condition even after training for an x^{th} time, then an x^{th} cycle of feature processing performed in an x^{th} feature processing network may be determined as the N^{th} cycle of feature processing corresponding to the second sample image. If, when the feature processing network is trained by using a third sample image, the feature processing network reaches the convergence condition (i.e., the feature training loss reaches the threshold condition) after training for the second time, then the second cycle of feature processing performed in a second feature processing network may be determined as the N^{th} cycle of feature processing corresponding to the second sample image.

In some embodiments, after the adjusting, when the feature training loss determined based on all the sample feature distances obtained after the first i cycles of feature processing does not reach a threshold condition, network parameters of the i^{th} feature processing network to obtain an (i+1)^{th} feature processing network, determining whether i is equal to the target threshold or not is further included. i is a positive integer, and i is greater than 1.

Further, the performing the (i+1)^{th} cycle of feature processing in the (i+1)^{th} feature processing network may include but is not limited to: when the i is determined to be less than the target threshold, performing the (i+1)^{th} cycle of feature processing in the (i+1)^{th} feature processing network. In some embodiments, after the determining whether i is equal to the target threshold or not, determining the i^{th} cycle of feature processing as the N^{th} cycle of feature processing when the i is determined to be equal to the target threshold is further included.

In some embodiments, after the determining, when the feature training loss determined based on all the sample feature distances obtained after the first i cycles of feature processing reaches the threshold condition, the i^{th} cycle of feature processing as the N^{th} cycle of feature processing, the method further includes: determining the i^{th} feature processing network as the feature processing network that has reached the convergence condition.

In some embodiments, for a implementation of extracting the original sample image features from the obtained k^{th} sample image, refer to but not limited to the related example of obtaining the image features based on the image to be recognized above. This is not limited in some embodiments. In some embodiments, M may be but not limited to be configured for indicating a total number of the sample images.

In some embodiments, the determining a sample feature distance between the (i−1)^{th} sample feature pair and the i^{th} sample feature pair based on feature differences between the (i−1)^{th} sample feature pair and the i^{th} sample feature pair includes: calculating a distance between an (i−1)^{th} sample image feature in the (i−1)^{th} sample feature pair and an i^{th} sample image feature in the i^{th} sample feature pair to obtain an (i−1)^{th} sample image feature distance; and calculating a distance between an (i−1)^{th} reference sample key point feature in the (i−1)^{th} sample feature pair and an i^{th} reference sample key point feature in the i^{th} sample feature pair to obtain an (i−1)^{th} reference sample key point feature distance.

Further, the performing weighted summation calculation on the first i sample feature distances to obtain an i^{th} feature training loss includes: performing weighted summation calculation on the first i sample image feature distances to obtain the sample image feature training loss, and performing weighted summation calculation on the first i reference sample key point feature distances to obtain the reference key point feature training loss; and performing weighted summation calculation on the sample image feature training loss and the reference key point feature training loss to obtain the i^{th} feature training loss.

For a implementation, refer to a relevant embodiment in the image recognition method. Details thereof are not described in some embodiments again.

In the embodiments of this application, the initialized feature processing network is trained based on a multi-cycle self-distillation manner so as to obtain an available feature processing network manner. The accuracy of network calculation results is ensured, and at the same time, the time consumed for network training is reduced. In a self-cyclic iterative training process of the feature processing network, new sample data is continuously generated (i.e., the sample image features and the reference sample key point features obtained after each cycle of feature processing may be used as new sample data), so that the resource loss in the training process can be greatly reduced. Therefore, the technical problem of low image recognition efficiency in an image recognition means provided in the related art is solved, and the technical effect of improving the image recognition efficiency is achieved.

In some embodiments, as an exemplary implementation, after in the i^{th} feature processing network for executing the i^{th} cycle of feature processing, feature processing is executed on the (i−1)^{th} sample feature pair obtained through the (i−1)^{th} cycle of feature processing to obtain the i^{th} sample feature pair, the method further includes:
inputting the i^{th} reference sample key point feature in the i^{th} sample feature pair to an i^{th} fully-connected layer to obtain an i^{th} key point prediction position;
comparing the i^{th} key point prediction position with a key point mark position in the k^{th} sample image to obtain an i^{th} key point prediction difference distance;
performing weighted summation calculation on the first i key point prediction difference distances to obtain an i^{th} key point prediction training loss;
performing weighted summation calculation on the i^{th} feature training loss and the i^{th} key point prediction training loss to obtain an i^{th} target loss;
adjusting, when the i^{th} target loss does not reach a threshold condition, network parameters in the i^{th} feature processing network and the i^{th} fully-connected layer to obtain the (i+1)^{th} feature processing network and an (i+1)^{th} fully-connected layer; performing a (i+1)^{th} cycle of feature processing in an (i+1)^{th} feature processing network, and obtaining an (i+1)^{th} key point prediction position in the (i+1)^{th} fully-connected layer; and
determining, when the i^{th} target loss reaches the threshold condition, the i^{th} cycle of feature processing as the N^{th} cycle of feature processing.

For a implementation, refer to a relevant embodiment in the image recognition method. Details thereof are not described in some embodiments again.

In the embodiments of this application, the initialized feature processing network and the fully-connected layer connected to the feature processing network are jointly trained based on a multi-cycle self-distillation manner so as to obtain an available feature processing network and fully-connected layer manner. The accuracy of network calculation results is ensured, and at the same time, the time consumed for network training is reduced. In a self-cyclic iterative training process of the feature processing network, new sample data is continuously generated (i.e., the sample image features and the reference sample key point features obtained after each cycle of feature processing may be used as new sample data), so that the resource loss in the training process can be greatly reduced. Therefore, the technical problem of low image recognition efficiency in an image recognition means provided in the related art is solved, and the technical effect of improving the image recognition efficiency is achieved.

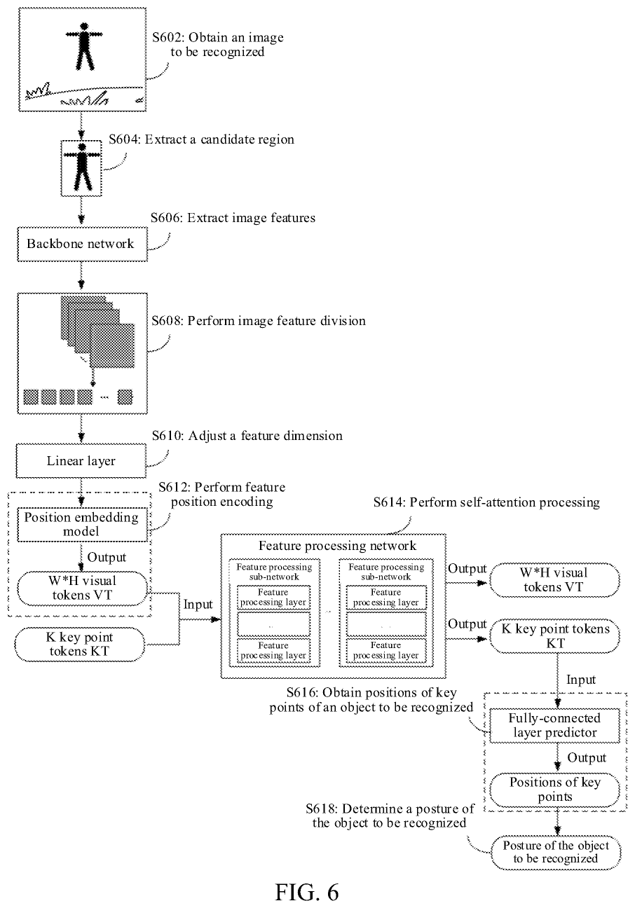

In some embodiments, as an exemplary implementation, if the image recognition method is applied to a posture estimation scenario, the method may be completely illustrated and described by using but not limited to the following operations shown in FIG. 6:
S602: An image to be recognized is obtained.
S604: A candidate region is extracted. Specifically, the candidate region of the object to be recognized in the image to be recognized is determined from the image to be recognized by using the region recognition network, and the candidate region is cropped from the image to be recognized.
S606: Image features are extracted. Specifically, image features corresponding to an image content displayed in the candidate region are extracted by using a Backbone network.
S608: Image feature division is performed. Specifically, the image features are divided into a plurality of sub-image features.
S610: A feature dimension is adjusted. Specifically, the feature dimension of the divided image features is adjusted by using a Linear network to obtain the adjusted image features.
S612: Feature position encoding is performed. Specifically, position encoding is performed on the adjusted image features by using a Position Embedding network to obtain W*H visual tokens VT (configured for indicating the image features above).
S614: Self-attention processing is performed. Specifically, additional K key point tokens KT (configured for indicating the above reference key point features) are inputted to a self-attention layer model (configured for indicating the feature processing network above) to obtain W*H visual tokens VT1 and K key point tokens KT1 processed by using an self-attention mechanism, and the K key point tokens KT1 processed by using the self-attention mechanism are determined as final key point features. For the feature processing network, N cycles of feature processing is performed on each sample image based on initialized feature processing network, in an i^{th} feature processing network for executing an i^{th} cycle of feature processing, feature processing is performed on an (i−1)^{th} sample feature pair obtained through an (i−1)^{th} cycle of feature processing to obtain an i^{th} sample feature pair, and network parameters of an i^{th} feature processing network are adjusted based on feature differences between the (i−1)^{th} sample feature pair and the i^{th} sample feature pair until a convergence condition is reached, i is greater than or equal to 1 and less than or equal to N, and N is a positive integer.
S616: Positions of key points of the object to be recognized are obtained. Specifically, the K key point tokens KT processed by using the self-attention mechanism are inputted to a fully-connected layer predictor (configured for indicating the fully-connected layer connected to the feature processing network above) to obtain the positions of the key points of the object to be recognized in the image to be recognized.
S618: A posture of the object to be recognized is determined. Specifically, a motion posture of the object to be recognized in the image to be recognized is determined by using the positions of the key points of the object to be recognized in the image to be recognized.

In the embodiments of this application, the feature processing network obtained based on the multi-cycle self-distillation training is configured for locating the positions, in the image to be recognized, of the key points of the object to be recognized in the image to be recognized. The accuracy of network calculation results is ensured, and at the same time, the time consumed for network training is reduced. The technical problem of low image recognition efficiency in an image recognition means provided in the related art is further solved, and the technical effect of improving the image recognition efficiency is achieved.

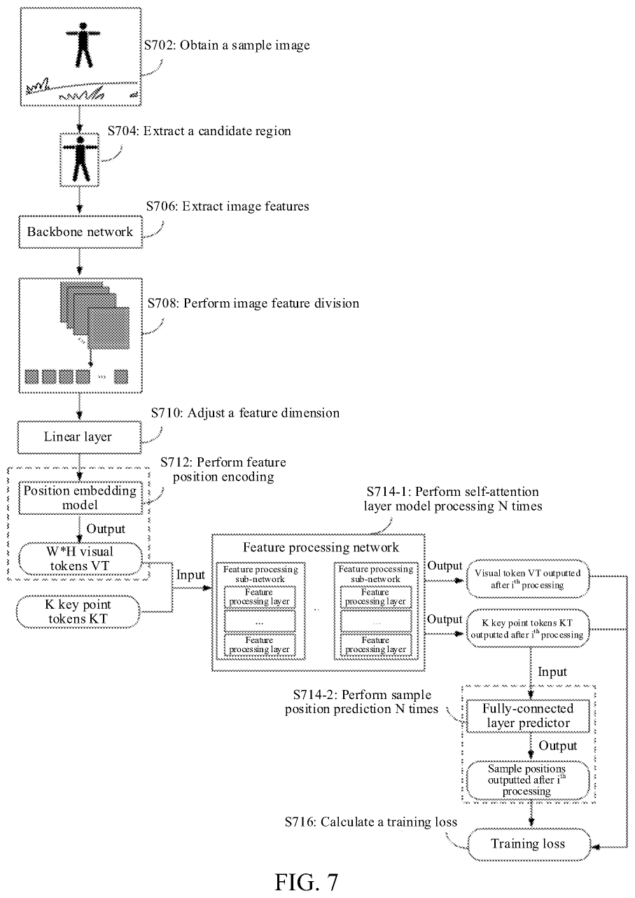

In some embodiments, as an exemplary implementation, the image recognition preprocessing method may be completely illustrated and described by using but not limited to the following operations shown in FIG. 7:
S702: A sample image is obtained. Then, S704 to S712 are performed, and a candidate region is extracted. Specifically, the candidate region of the object to be recognized in the sample image is determined from the image to be recognized by using the region recognition network, and the candidate region is cropped from the sample image. Image features are extracted. Specifically, image features corresponding to an image content displayed in the candidate region are extracted by using a Backbone network. Image feature division is performed. Specifically, the image features are divided into a plurality of sub-image features. A feature dimension is adjusted. Specifically, the feature dimension of the divided image features is adjusted by using a Linear network to obtain the adjusted image features. Feature position encoding is performed. Specifically, position encoding is performed on the adjusted image features by using a Position Embedding network to obtain W*H visual tokens VT (configured for indicating the sample image features above).

Next, S714-1 is performed, and self-attention layer model processing are performed N times. Specifically, K key point tokens KT (configured for indicating the reference sample key point features above) obtained through additional initialization are inputted to a self-attention layer model (configured for indicating the feature processing network above), and are processed N times through the self-attention layer model. For a i^{th} processing, the output of the self-attention layer model is a new visual token VT; and a key point token KTᵢ, and the input is a visual token VTᵢ₋₁ and a key point token KTᵢ₋₁ from a previous cycle. S714-2 is performed, and sample position prediction are performed N times. Specifically, for the key point token KTᵢ, i∈{1, 2 . . . . N} outputted each time, the key point token is sent to the same fully-connected layer predictor to obtain a posture estimation outputpredᵢ, i∈{1, 2 . . . N}. Each posture estimation output includes K key point coordinates \hat{x}, i∈{1, 2 . . . K} in the posture.

Further, S716 is performed, and a training loss is calculated. Specifically, a sum Lₚₒₛₑ of minimum MSE distances between each training prediction posture estimation output and the target posture is obtained, a total loss [symbol] between every two adjacent key point tokens KT is obtained, a total loss [symbol] between every two adjacent visual tokens VT is obtained, and a training loss value is generated by using [symbol] , [symbol] , and [symbol] . Further, when the training loss value reaches a threshold, the self-attention layer model and the fully-connected layer predictor are determined to reach the convergence condition. Otherwise, the training processing will continue to be performed on the self-attention layer model and the fully-connected layer predictor with reference to the foregoing operations.

In the embodiments of this application, the initialized feature processing network is trained based on a multi-cycle self-distillation manner so as to obtain an available feature processing network manner. The accuracy of network calculation results is ensured, and at the same time, the time consumed for network training is reduced. In a self-cyclic iterative training process of the feature processing network, new sample data is continuously generated (i.e., the sample image features and the reference sample key point features obtained after each cycle of feature processing may be used as new sample data), so that the resource loss in the training process can be greatly reduced. Therefore, the technical problem of low image recognition efficiency in an image recognition means provided in the related art is solved, and the technical effect of improving the image recognition efficiency is achieved.

TABLE 1
Comparison of results between some embodiments and the related
art on verification set of public dataset MSCOCO [8]

| | Backbone | Input | Parameter | | |
|---|---|---|---|---|---|
| Manner | network | size | quantity (M) | GFLOPs | mAP(%) |
| SimpleBaselines[1] | ResNet-50[6] | 256 × 192 | 34.0 | 8.90 | 70.4 |
| SimpleBaselines[1] | ResNet-152[6] | 256 × 192 | 68.6 | 15.70 | 72.0 |
| TokenPose[2] | Stemnet[5] | 256 × 192 | 6.6 | 2.4 | 69.5 |
| OKDHP[3] | Hourglass[9] | 256 × 192 | 13.0 | 25.5 | 72.8 |
| PPT[4] | Stemnet[5] | 256 × 192 | 6.6 | 2.0 | 70.8 |
| PPT[4] | HRNet-W32 [7] | 256 × 192 | 13.2 | 4.7 | 73.4 |
| DistilPose-S[5] | Stemnet[5] | 256 × 192 | 5.4 | 2.38 | 71.6 |
| This embodiment | Stemnet[5] | 256 × 192 | 4.4 | 1.8 | 69.7 |
| This embodiment | Stemnet[5] | 256 × 192 | 6.6 | 2.4 | 72.3 |
| This embodiment | HRNet-W32 [7] | 256 × 192 | 13.2 | 5.2 | 73.7 |

Table 1 shows effects of some embodiments and other related art in the field of posture estimation on the verification set of the public dataset (MSCOCO). Evaluation metrics including parameter quantity, GFLOPs and mAP. The parameter quantity and the GFLOPs represent a model speed, and the smaller parameter quantity and GFLOPs, the faster the model runs. mAP represents a model prediction accuracy, and the higher the mAP, indicates the more accurate the model prediction. Herein, ResNet-50 and Stemnet are small backbone networks, and ResNet-152 and HRNet are large backbone networks. The larger W coefficient of the HRNet, the deeper and wider network layers and the larger the model. In comparison, ResNet-50 is larger than Stemnet, and HRNet-W32 and ResNet-152 have a small difference in size. That is, the effect of some embodiments far superior to that of another related art.

For ease of description, the method embodiments are described as a series of action combinations. However, a person skilled in the art is to know that this application is not limited to the described order of the actions because some operations may be performed in another order or performed at the same time according to this application. In addition, a person skilled in the art is also to be aware that all the embodiments described in this specification are exemplary embodiments, and the related actions and modules are not necessarily mandatory to this application.

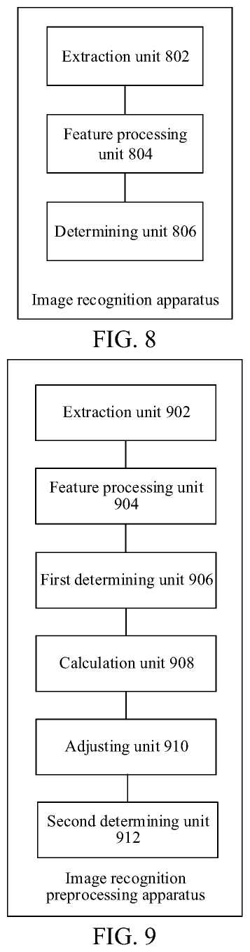

According to another aspect of embodiments of this application, an image recognition apparatus for implementing the image recognition method is further provided. As shown in FIG. 8, the apparatus further includes:
an extraction unit 802, configured to extract image features from an image to be recognized, an object to be recognized being displayed in the image to be recognized;
a feature processing unit 804, configured to perform feature processing through a feature processing network on the image features and reference key point features obtained through initialization to obtain final key point features of the object to be recognized, the final key point features being configured for indicating features of key points recognized from the object to be recognized displayed in the image to be recognized, the feature processing network being obtained through performing N cycles of feature processing on each sample image based on an initialized feature processing network, performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, and adjusting network parameters of the i^{th} feature processing network based on feature differences between the (i−1)^{th} sample feature pair and the i^{th} sample feature pair until a convergence condition is reached, i being a positive integer greater than or equal to 1 and less than or equal to N, N being a positive integer, the i^{th} sample feature pair including i^{th} sample image features and i^{th} reference sample key point features, the i^{th} sample image features being obtained through performing i cycles of feature processing based on original sample image features extracted from the sample images, and the i^{th} reference sample key point features being obtained through performing i cycles of feature processing based on original reference sample key point features obtained through initialization; and
a determining unit 806, configured to determine, by using the final key point features, positions of the key points of the object to be recognized in the image to be recognized.

In some embodiments, the feature processing unit includes an input module, a feature processing module, and a determining module. The input module is configured to input the obtained (j−1)^{th} image feature and (j−1)^{th} reference key point feature outputted by a (j−1)^{th} feature processing sub-network in the feature processing network to a j^{th} feature processing sub-network in the feature processing network, and the feature processing network includes P feature processing sub-networks, j is greater than 1 and less than or equal to P, and P is a positive integer. The feature processing module is configured to perform, in the j^{th} feature processing sub-network, cycle feature processing on the (j−1)^{th} image feature and the (j−1)^{th} reference key point feature to obtain a j^{th} image feature and a j^{th} reference key point feature. The determining module is configured to determine the j^{th} reference key point feature as the final key point feature when j is equal to P; and input the obtained j^{th} image feature and j^{th} reference key point feature into a (j+1)^{th} feature processing sub-network in the feature processing network to perform a (j+1)^{th} cycle of feature processing when j is less than P.

In some embodiments, the feature processing module is further configured to perform the following operation in the j^{th} feature processing sub-network: in a first feature processing layer of the j^{th} feature processing sub-network, linear transformation processing is performed on an image sub-feature outputted by a (j−1)^{th} feature processing sub-network to obtain a first image sub-feature; linear transformation processing is performed on a reference key point sub-feature outputted by a (j−1)^{th} feature processing sub-network to obtain a first reference key point sub-feature; in an h^{th} feature processing layer of the j^{th} feature processing sub-network, an (h−1)^{th} image sub-feature and an (h−1)^{th} reference key point sub-feature outputted by an (h−1)^{th} feature processing layer of the j^{th} feature processing sub-network are inputted to the h^{th} feature processing layer in the j^{th} feature processing sub-network, and h is a positive integer greater than or equal to 2; in the h^{th} feature processing layer, linear transformation processing is performed on the (h−1)^{th} image sub-feature to obtain a first processing result, and the first processing result is determined as the h^{th} image sub-feature outputted by the h^{th} feature processing layer; linear transformation processing is performed on the (h−1)^{th} reference key point sub-feature to obtain a second processing result; and an h^{th} reference key point sub-feature outputted by the h^{th} feature processing layer is obtained by using the first processing result and the second processing result; and when the h^{th} feature processing layer is the last feature processing layer in the j^{th} feature processing sub-network, the h^{th} image sub-feature is determined as a j^{th} image feature outputted by the j^{th} feature processing sub-network, and the h^{th} reference key point sub-feature is determined as a j^{th} reference key point feature outputted by the j^{th} feature processing sub-network.

In some embodiments, the apparatus further includes a first extraction unit, a first feature processing unit, a first determining unit, a calculation unit, an adjusting unit, and a second determining unit. The first extraction unit is configured to extract original sample image features from an obtained k^{th} sample image, and obtain original reference sample key point features obtained through initialization, k is a positive integer greater than or equal to 1 and less than or equal to M, and M is a positive integer. The first feature processing unit is configured to perform, in an i^{th} feature processing network performing the i^{th} cycle of feature processing, feature processing on an (i−1)^{th} sample feature pair obtained through the (i−1)^{th} cycle of feature processing to obtain an i^{th} sample feature pair, the (i−1)^{th} sample feature pair obtained through the (i−1)^{th} cycle of feature processing is configured for indicating the original sample feature pair when i is 1, and the original sample feature pair includes the original sample image features and the original reference sample key point features. The first determining unit is configured to determine a sample feature distance between the (i−1)^{th} sample feature pair and the i^{th} sample feature pair based on the feature difference between the (i−1)^{th} sample feature pair and the i^{th} sample feature pair. The calculation unit is configured to perform weighted summation calculation on the first i sample feature distances to obtain an i^{th} feature training loss. The adjusting unit is configured to adjust, when the feature training loss determined based on all the sample feature distances obtained after the first i cycles of feature processing does not reach a threshold condition, network parameters of the i^{th} feature processing network to obtain an (i+1)^{th} feature processing network; and perform the (i+1)^{th} cycle of feature processing in the (i+1)^{th} feature processing network. The second determining unit is configured to determine, when the feature training loss determined based on all the sample feature distances obtained after the first i cycles of feature processing reaches the threshold condition, the i^{th} cycle of feature processing as the N^{th} cycle of feature processing.

In some embodiments, the first determining unit includes: a first calculation module, configured to calculate a distance between the (i−1)^{th} sample image feature in the (i−1)^{th} sample feature pair and the i^{th} sample image feature in the i^{th} sample feature pair to obtain an (i−1)^{th} sample image feature distance; and a second calculation module, configured to calculate the distance between the (i−1)^{th} reference sample key point feature in the (i−1)^{th} sample feature pair and the i^{th} reference sample key point feature in the i^{th} sample feature pair to obtain the (i−1)^{th} reference sample key point feature distance.

In some embodiments, the first determining unit further includes: a third calculation module, configured to perform weighted summation calculation on the first i sample image feature distances to obtain a sample image feature training loss, and perform weighted summation calculation on the first i reference sample key point feature distances to obtain a reference key point feature training loss; and a fourth calculation module, configured to perform weighted summation calculation on the feature training loss and the reference key point feature training loss to obtain the i^{th} feature training loss.

In some embodiments, the apparatus further includes: a first input unit, configured to input the i^{th} reference sample key point feature in the i^{th} sample feature pair to an i^{th} fully-connected layer to obtain an i^{th} key point prediction position; a comparison unit, configured to compare the i^{th} key point prediction position with a key point mark position in the k^{th} sample image to obtain an i^{th} key point prediction difference distance; a first calculation unit, configured to perform weighted summation calculation on the first i key point prediction difference distances to obtain an i^{th} key point prediction training loss; a second calculation unit, configured to perform weighted summation calculation on the i^{th} feature training loss and the i^{th} key point prediction training loss to obtain an i^{th} target loss; a first adjusting unit, configured to adjust, when the i^{th} target loss does not reach the threshold condition, network parameters in the i^{th} feature processing network and the i^{th} fully-connected layer to obtain the (i+1)^{th} feature processing network and the (i+1)^{th} fully-connected layer, execute the (i+1)^{th} cycle of feature processing in the (i+1)^{th} feature processing network, and obtain the (i+1)^{th} key point prediction position in the (i+1)^{th} fully-connected layer; and a third determining unit, configured to determine the i^{th} cycle of feature processing as the N^{th} cycle of feature processing when the i^{th} target loss reaches the threshold condition.

For a embodiment, refer to the example in the image recognition method above. Details are not described in some embodiments again.

According to another aspect of embodiments of this application, an image recognition preprocessing apparatus for implementing the image recognition preprocessing method is further provided. As shown in FIG. 9, the apparatus further includes:

an extraction unit 902, configured to extract original sample image features from an obtained k^{th} sample image, and obtain original reference sample key point features obtained through initialization, k being a positive integer greater than or equal to 1 and less than or equal to M, and M being a positive integer;
a feature processing unit 904, configured to perform, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, the (i−1)^{th} sample feature pair obtained through the (i−1)^{th} cycle of feature processing being configured for indicating an original sample feature pair when i is 1, and the original sample feature pair including the original sample image features and the original reference sample key point features;
a first determining unit 906, configured to determine a sample feature distance between the (i−1)^{th} sample feature pair and the i^{th} sample feature pair based on feature differences between the (i−1)^{th} sample feature pair and the i^{th} sample feature pair;
a calculation unit 908, configured to perform weighted summation calculation on the first i sample feature distances to obtain an i^{th} feature training loss;
an adjusting unit 910, configured to adjust, when a feature training loss determined based on all the sample feature distances obtained after the first i cycles of feature processing does not reach a threshold condition, network parameters of the i^{th} feature processing network to obtain an (i+1)^{th} feature processing network; and perform an (i+1)^{th} cycle of feature processing in the (i+1)^{th} feature processing network;
a second determining unit 912, configured to determine, when the feature training loss determined based on all the sample feature distances obtained after the first i cycles of feature processing reaches the threshold condition, the i^{th} cycle of feature processing as the N^{th} cycle of feature processing.

In some embodiments, the apparatus further includes: an input unit, configured to input the i^{th} reference sample key point feature in the i^{th} sample feature pair to an i^{th} fully-connected layer to obtain an i^{th} key point prediction position; a comparison unit, configured to compare the i^{th} key point prediction position with a key point mark position in the k^{th} sample image to obtain an i^{th} key point prediction difference distance; a first calculation unit, configured to perform weighted summation calculation on the first i key point prediction difference distances to obtain an i^{th} key point prediction training loss; a second calculation unit, configured to perform weighted summation calculation on the i^{th} feature training loss and the i^{th} key point prediction training loss to obtain an i^{th} target loss; a first adjusting unit, configured to adjust, when the i^{th} target loss does not reach the threshold condition, network parameters in the i^{th} feature processing network and the i^{th} fully-connected layer to obtain the (i+1)^{th} feature processing network and the (i+1)^{th} fully-connected layer, execute the (i+1)^{th} cycle of feature processing in the (i+1)^{th} feature processing network, and obtain the (i+1)^{th} key point prediction position in the (i+1)^{th} fully-connected layer; and a third determining unit, configured to determine the i^{th} cycle of feature processing as the N^{th} cycle of feature processing when the i^{th} target loss reaches the threshold condition.

For a embodiment, refer to an example in the image recognition preprocessing method. Details are not described in some embodiments again.

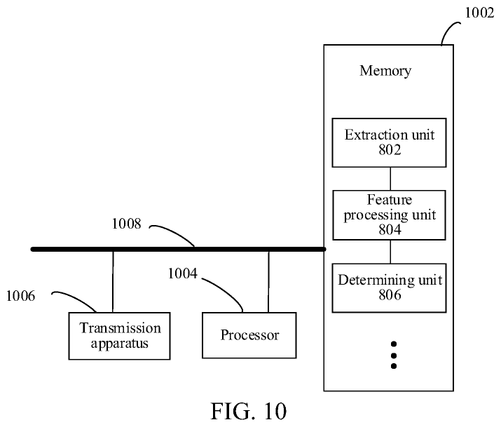

According to another aspect of embodiments of this application, an electronic device for implementing the image recognition method is further provided. The electronic device may be a terminal device or a server as shown in FIG. 1. Some embodiments is described by taking the electronic device being a terminal as an example. As shown in FIG. 10, the electronic device includes a memory 1002 and a processor 1004. The memory 1002 has a computer program stored therein, and the processor 1004 is configured to perform operations in any one of the method embodiments through the computer program.

In some embodiments, the electronic device may be located in at least one of a plurality of network devices in a computer network.

In some embodiments, the processor may be configured to perform the operations of any one method embodiment through the computer program.

In some embodiments, a person of ordinary skill in the art may understand that a structure shown in FIG. 10 is merely an example. The electronic device may also be a terminal device such as a smartphone (such as an Android mobile phone or an iOS mobile phone), a tablet computer, a palmtop computer, a mobile Internet device (MID), or a PAD. FIG. 10 does not construct limitation to the structure of the electronic device. For example, the electronic device may further include more or fewer components (such as a network interface) than those shown in FIG. 10, or may have a configuration different from that shown in FIG. 10.

The memory 1002 may be configured to store a software program and a module, such as a program instruction/module corresponding to the image recognition method and apparatus in the embodiments of this application. The processor 1004 runs the software program and the module stored in the memory 1002 to execute various functional applications and data processing, and the image recognition method is realized. The memory 1002 may include a high-speed random access memory, and may further include a non-volatile memory, such as one or more magnetic disk storage apparatuses, flash memories, or other volatile solid-state memories. In some embodiments, the memory 1002 may further include memories remotely disposed relative to the processor 1004. These remote memories may be connected to the terminal over a network. Examples of the network include but are not limited to the Internet, an intranet, a local area network, a mobile communication network, and a combination thereof. The memory 1002 may be but not limited to be configured to store the image to be recognized. In an example, as shown in FIG. 10, the memory 1002 may include but is not limited to the extraction unit 802, the feature processing unit 804, and the determining unit 806 in the image recognition apparatus. In addition, the memory may further include but is not limited to another module unit in the image recognition apparatus. Details are not described in this example again.

In some embodiments, the transmission apparatus 1006 is configured to receive or send data over a network, examples of the network may include a wired network and a wireless network. In an example, the transmission apparatus 1006 includes a network interface controller (NIC) which may be connected to another network device and a router through a network cable so as to communicate with the Internet or a local area network. In an example, the transmission apparatus 1006 is a radio frequency (RF) module, and is configured to be communicated with the Internet in a wireless manner.

In addition, the electronic device further includes a connection bus 1008 configured to connect each module component in the electronic device.

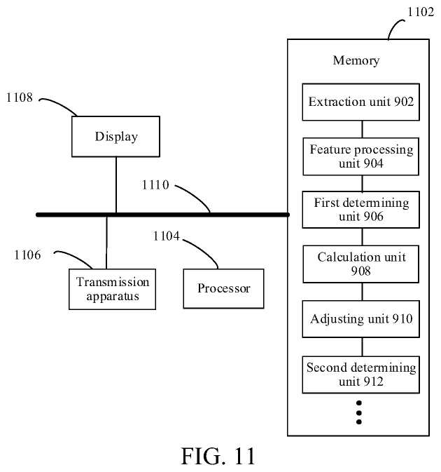

According to another aspect of embodiments of this application, an electronic device for implementing the image recognition preprocessing method is further provided. The electronic device may be a terminal device or a server as shown in FIG. 1. Some embodiments is described by taking the electronic device being a server as an example. As shown in FIG. 11, the electronic device includes a memory 1102 and a processor 1104. The memory 1102 has a computer program stored therein, and the processor 1104 is configured to perform operations in any one of the method embodiments through the computer program.

In some embodiments, the electronic device may be located in at least one of a plurality of network devices in a computer network.

In some embodiments, the processor may be configured to perform the following operations through the computer program:
obtaining M sample images and an initialized feature processing network, and performing training through the following operations:
extracting original sample image features from an obtained k^{th} sample image, and obtaining original reference sample key point features obtained through random initialization, k being a positive integer greater than or equal to 1 and less than or equal to M, and M being a positive integer; and
repeatedly performing the following operations on the original sample image features and the original reference sample key point features until N cycles of feature processing are performed:
performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, the (i−1)^{th} sample feature pair obtained through the (i−1)^{th} cycle of feature processing being configured for indicating the original sample feature pair when i is 1, and the original sample feature pair comprising the original sample image features and the original reference sample key point features;
determining a sample feature distance between the (i−1)^{th} sample feature pair and the i^{th} sample feature pair based on the feature difference between the (i−1)^{th} sample feature pair and the i^{th} sample feature pair;
performing weighted summation calculation on the first i sample feature distances to obtain an i^{th} feature training loss; adjusting, when the feature training loss determined based on all the sample feature distances obtained after the first i cycles of feature processing does not reach the threshold condition, network parameters of the i^{th} feature processing network to obtain the (i+1)^{th} feature processing network;
the (i+1)^{th} cycle of feature processing is performed in the (i+1)^{th} feature processing network; and
determining, when the feature training loss determined based on all the sample feature distances obtained after the first i cycles of feature processing reaches the threshold condition, the i^{th} cycle of feature processing as the N^{th} cycle of feature processing.

In some embodiments, a person of ordinary skill in the art may understand that a structure shown in FIG. 11 is merely an example. The electronic device may also be a terminal device such as a smartphone (such as an Android mobile phone or an iOS mobile phone), a tablet computer, a palmtop computer, a mobile Internet device (MID), or a PAD. FIG. 11 does not construct limitation to the structure of the electronic device. For example, the electronic device may further include more or fewer components (such as a network interface) than those shown in FIG. 11, or may have a configuration different from that shown in FIG. 11.

The memory 1102 may be configured to store a software program and a module, such as a program instruction/module corresponding to the image recognition preprocessing method and apparatus in the embodiments of this application. The processor 1104 runs the software program and the module stored in the memory 1102 to execute various functional applications and data processing, and the image recognition preprocessing method is realized. The memory 1102 may include a high-speed random access memory, and may further include a non-volatile memory, such as one or more magnetic disk storage apparatuses, flash memories, or other volatile solid-state memories. In some embodiments, the memory 1102 may further include memories remotely disposed relative to the processor 1104, and these remote memories may be connected to the terminal through a network. Examples of the network include but are not limited to the Internet, an intranet, a local area network, a mobile communication network, and a combination thereof. The memory 1102 may be but not limited to be configured to store the sample image. In an example, as shown in FIG. 11, the memory 1102 may include but is not limited to the extraction unit 902, the feature processing unit 904, the first determining unit 906, the calculation unit 908, the adjusting unit 910, and the second determining unit 912 in the image recognition preprocessing apparatus. In addition, the memory may further include but is not limited to another module unit in the image recognition preprocessing apparatus. Details are not described in this example again.

In some embodiments, the transmission apparatus 1106 is configured to receive or send data through a network, examples of the network may include a wired network and a wireless network. In an example, the transmission apparatus 1106 includes a network interface controller (NIC) which may be connected to another network device and a router through a network cable so as to be communicated with the Internet or a local area network. In an example, the transmission apparatus 1106 is a radio frequency (RF) module, and is configured to be communicated with the Internet in a wireless manner.

In addition, the electronic device further includes: a display 1108 configured to display the sample image; and a connection bus 1110 configured to connect each module component in the electronic device.

In another embodiment, the terminal device or the server may be a node in a distributed system. The distributed system may be a blockchain system. The blockchain system may be a distributed system formed by connecting a plurality of nodes in a network communication form. A point-to-point network may be formed between nodes. Any form of computing device, such as the server, the terminal, and another electronic device, may join the point-to-point network as a node in the blockchain system.

According to an aspect of this application, a computer program product is provided. The computer program product includes a computer program/instruction. The computer program/instruction includes a program code for executing the method. In such some embodiments, the computer program may be downloaded from a network through the communication part and installed, and/or installed from a removable medium. When the computer program is executed by a central processing unit, various functions provided in the embodiments of this application are executed.

According to an aspect of this application, a computer-readable storage medium is provided. A processor of a computer device reads the computer program from the computer-readable storage medium. The processor executes the computer program, so that the computer device implements the method.

In some embodiments, the computer-readable storage medium may be configured to store the computer program for performing the operations in the method embodiments:

In some embodiments, the computer-readable storage medium may further be configured to store a computer program for performing the following operations in the image recognition preprocessing method:
obtaining M sample images and an initialized feature processing network, and performing training through the following operations:
extracting original sample image features from an obtained k^{th} sample image, and obtaining original reference sample key point features obtained through initialization, k being a positive integer greater than or equal to 1 and less than or equal to M, and M being a positive integer; and
repeatedly performing the following operations on the original sample image features and the original reference sample key point features until N cycles of feature processing are performed:
performing, in an i^{th} feature processing network for executing an i^{th} cycle of feature processing, feature processing on an (i−1)^{th} sample feature pair obtained through an (i−1)^{th} cycle of feature processing to obtain an i^{th} sample feature pair, the (i−1)^{th} sample feature pair obtained through the (i−1)^{th} cycle of feature processing being configured for indicating the original sample feature pair when i is 1, and the original sample feature pair comprising the original sample image features and the original reference sample key point features;
determining a sample feature distance between the (i−1)^{th} sample feature pair and the i^{th} sample feature pair based on the feature difference between the (i−1)^{th} sample feature pair and the i^{th} sample feature pair;
performing weighted summation calculation the first i sample feature distances to obtain the i^{th} feature training loss; adjusting, when the feature training loss determined based on all the sample feature distances obtained after the first i cycles of feature processing does not reach the threshold condition, network parameters of the i^{th} feature processing network to obtain the (i+1)^{th} feature processing network; the (i+1)^{th} cycle of feature processing is performed in the (i+1)^{th} feature processing network; and
determining, when the feature training loss determined based on all the sample feature distances obtained after the first i cycles of feature processing reaches the threshold condition, the i^{th} cycle of feature processing as the N^{th} cycle of feature processing.

In the embodiments of this application, the term “module” or “unit” refers to a computer program with a preset function or a part of the computer program and works together with other related parts to achieve a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an overall module or unit including the module or unit function.

In some embodiments, a person of ordinary skill in the art may understand that all or some operations in various methods of the embodiments may be performed by a program instructing relevant hardware of the terminal device. The program may be stored in a computer-readable storage medium. The storage medium may include a flash disk, a read-only memory (ROM), a random access memory (RAM), a magnetic disk, an optical disc, etc.

When the integrated unit in the embodiments is implemented in a form of a software function unit, and sold or used as an independent product, the integrated unit may be stored in the computer-readable storage medium. Based on such understanding, the technical solutions of this application essentially, or the part contributing to the related art, or all or some of the technical solutions may be implemented in the form of a software product. The computer software product is stored in a storage medium and includes several instructions for instructing one or more computer devices (which may be a personal computer, a server, a network device, etc.) to implement all or some of the operations of the methods in each embodiment of this application.

In the embodiments of this application, the descriptions of each embodiment have respective focuses. For a part that is not described in detail in some embodiments, reference can be made to related descriptions in other embodiments.

In the several embodiments provided in this application, the disclosed client may be implemented in other manners. The described apparatus embodiment is merely an example. For example, unit division is merely logical function division, and there may be other division manners during actual implementation. For example, a plurality of units or components may be combined or integrated into another system, or some features may be ignored or not performed. In addition, the mutual coupling, direct coupling or communication connection which is displayed or discussed may be indirect coupling or communication connection through some interfaces, units or modules, or may be implemented in an electronic form or other forms.

The units described as separate parts may or may not be physically separated, and parts displayed as units may or may not be physical units. That is, they may be located in one position, or may be distributed on a plurality of network units. Some or all of the units may be selected according to actual may achieve the objectives of the solutions of the embodiments.

In addition, the function units in each embodiment of this application may be integrated into one processing unit, or each of the units may exist alone physically, or two or more units may be integrated into one unit. The above integrated unit may be implemented in a form of hardware, or may be implemented in a form of a software function unit.

The above descriptions are merely the exemplary implementations of this application. A person of ordinary skill in the art may further make several improvements and modifications without departing from the principle of this application, and these improvements and modifications are also considered to be within the protection scope of this application.

What is claimed is:

1. An image recognition method, performed by an electronic device, the method comprising:
extracting image features from an image to be recognized, the image to be recognized displaying an object to be recognized;
performing, via a feature processing network, feature processing on the image features and reference key point features obtained through initialization to obtain final key point features of the object to be recognized, the final key point features indicating features of key points of the object to be recognized in the image to be recognized; and
determining positions of the key points of the object to be recognized in the image to be recognized based on the final key point features,
wherein the feature processing network is obtained by performing N cycles of feature processing on each sample image using an initialized feature processing network, wherein an i^{th} cycle of feature processing comprises:
performing, via an i^{th} feature processing network, feature processing on an (i−1)^{th} sample feature pair obtained from an (i−1)^{th} cycle of feature processing to obtain an i^{th} sample feature pair; and
adjusting network parameters of the i^{th} feature processing network based on feature differences between the (i−1)^{th} sample feature pair and the i^{th} sample feature pair until a convergence condition is reached,
wherein i is an integer from 1 to N, and N is a positive integer,
wherein the i^{th} sample feature pair comprises i^{th} sample image features and i^{th} reference sample key point features,
wherein the i^{th} sample image features are obtained by performing i cycles of feature processing on original sample image features extracted from the sample images, and
wherein the i^{th} reference sample key point features are obtained by performing i cycles of feature processing on original reference sample key point features obtained through initialization.

2. The method according to claim 1, wherein the feature processing network comprises P feature processing sub-networks, wherein P is a positive integer, and wherein the performing feature processing comprises:
performing the following operations in the feature processing network:
inputting a (j−1)^{th} image feature and a (j−1)^{th} reference key point feature output by a (j−1)^{th} feature processing sub-network to a j^{th} feature processing sub-network, wherein j is an integer greater than 1 and less than or equal to P;
performing feature processing on the (j−1)^{th} image feature and the (j−1)^{th} reference key point feature in the j^{th} feature processing sub-network to obtain a j^{th} image feature and a j^{th} reference key point feature;
based on j being equal to P, determining the j^{th} reference key point feature as the final key point feature; and
based on j being less than P, inputting the j^{th} image feature and the j^{th} reference key point feature into a (j+1)^{th} feature processing sub-network to perform a (j+1)^{th} cycle of feature processing.

3. The method according to claim 2, wherein the performing feature processing in the j^{th} feature processing sub-network comprises:
performing the following operations in the j^{th} feature processing sub-network:
in a first feature processing layer of the j^{th} feature processing sub-network, performing linear transformation processing on an image sub-feature output by the (j−1)^{th} feature processing sub-network to obtain a first image sub-feature; and performing linear transformation processing on a reference key point sub-feature output by the (j−1)^{th} feature processing sub-network to obtain a first reference key point sub-feature;
in an h^{th} feature processing layer of the j^{th} feature processing sub-network, inputting an (h−1)^{th} image sub-feature and an (h−1)^{th} reference key point sub-feature output by an (h−1)^{th} feature processing layer to the h^{th} feature processing layer, wherein h is an integer greater than or equal to 2;
in the h^{th} feature processing layer, performing linear transformation processing on the (h−1)^{th} image sub-feature to obtain a first processing result, and determining the first processing result as the h^{th} image sub-feature output by the h^{th} feature processing layer; performing linear transformation processing on the (h−1)^{th} reference key point sub-feature to obtain a second processing result; and obtaining an h^{th} reference key point sub-feature output by the h^{th} feature processing layer based on the first processing result and the second processing result; and
based on the h^{th} feature processing layer being the last feature processing layer in the j^{th} feature processing sub-network, determining the h^{th} image sub-feature as the j^{th} image feature output by the j^{th} feature processing sub-network, and determining the h^{th} reference key point sub-feature as the j^{th} reference key point feature output by the j^{th} feature processing sub-network.

4. The method according to claim 1, further comprising, before the extracting image features:
training the initialized feature processing network through the following operations:
extracting original sample image features from a k^{th} sample image, and obtaining original reference sample key point features through initialization, wherein k is an integer from 1 to M, and M is a positive integer; and
repeatedly performing the following operations on the original sample image features and the original reference sample key point features until N cycles of feature processing are performed:
performing, via the i^{th} feature processing network for the i^{th} cycle of feature processing, feature processing on the (i−1)^{th} sample feature pair obtained from the (i−1)^{th} cycle of feature processing to obtain the i^{th} sample feature pair, the (i−1)^{th} sample feature pair being the original sample feature pair when i is 1, the original sample feature pair comprising the original sample image features and the original reference sample key point features;
determining a sample feature distance between the (i−1)^{th} sample feature pair and the i^{th} sample feature pair based on feature differences between the (i−1)^{th} sample feature pair and the i^{th} sample feature pair;
performing weighted summation calculation on the first i sample feature distances to obtain an i^{th} feature training loss;
based on the i^{th} feature training loss not reaching a threshold condition, adjusting network parameters of the i^{th} feature processing network to obtain an (i+1)^{th} feature processing network, and performing the (i+1)^{th} cycle of feature processing in the (i+1)^{th} feature processing network; and
based on the i^{th} feature training loss reaching the threshold condition, determining the i^{th} cycle of feature processing as the N^{th} cycle of feature processing.

5. The method according to claim 4, wherein the determining the sample feature distance comprises:
calculating a distance between an (i−1)^{th} sample image feature in the (i−1)^{th} sample feature pair and an i^{th} sample image feature in the i^{th} sample feature pair to obtain an (i−1)^{th} sample image feature distance; and
calculating a distance between an (i−1)^{th} reference sample key point feature in the (i−1)^{th} sample feature pair and an i^{th} reference sample key point feature in the i^{th} sample feature pair to obtain an (i−1)^{th} reference sample key point feature distance, wherein the sample feature distance comprises the (i−1)^{th} sample image feature distance and the (i−1)^{th} reference sample key point feature distance.

6. The method according to claim 5, wherein the performing weighted summation calculation to obtain the i^{th} feature training loss comprises:
performing weighted summation calculation on the first i sample image feature distances to obtain a sample image feature training loss, and performing weighted summation calculation on the first i reference sample key point feature distances to obtain a reference key point feature training loss; and
performing weighted summation calculation on the sample image feature training loss and the reference key point feature training loss to obtain the i^{th} feature training loss.

7. The method according to claim 4, further comprising, after the performing feature processing to obtain the i^{th} sample feature pair:
inputting the i^{th} reference sample key point feature in the i^{th} sample feature pair to an i^{th} fully-connected layer to obtain an i^{th} key point prediction position;
comparing the i^{th} key point prediction position with a key point mark position in the k^{th} sample image to obtain an i^{th} key point prediction difference distance;
performing weighted summation calculation on the first i key point prediction difference distances to obtain an i^{th} key point prediction training loss;
performing weighted summation calculation on the i^{th} feature training loss and the i^{th} key point prediction training loss to obtain an i^{th} target loss;
based on the i^{th} target loss not reaching the threshold condition, adjusting network parameters in the i^{th} feature processing network and the i^{th} fully-connected layer to obtain an (i+1)^{th} feature processing network and an (i+1)^{th} fully-connected layer, performing an (i+1)^{th} cycle of feature processing in the (i+1)^{th} feature processing network, and obtaining an (i+1)^{th} key point prediction position in the (i+1)^{th} fully-connected layer; and
based on the i^{th} target loss reaching the threshold condition, determining the i^{th} cycle of feature processing as the N^{th} cycle of feature processing.

8. The method according to claim 1, wherein the extracting image features comprises:
performing recognition processing on the image to be recognized using a region recognition network to determine a candidate region in which the object to be recognized is located in the image to be recognized;
cropping the image to be recognized to reserve the candidate region;
extracting image features corresponding to an image content displayed in the candidate region using a feature extraction network;
adjusting a feature dimension of the image features to a preset dimension to obtain adjusted image features; and
performing position encoding processing on the adjusted image features to obtain image visual tokens, the image visual tokens being determined as the image features.

9. The method according to claim 1, wherein the determining positions of the key points comprises:
performing mapping processing on the final key point features using a fully-connected layer connected to the feature processing network to obtain the positions of the key points of the object to be recognized in the image to be recognized.

10. The method according to claim 1, wherein the feature processing network comprises a plurality of feature processing sub-networks, and wherein each of the plurality of feature processing sub-networks comprises a plurality of feature processing layers, and
wherein a first feature processing layer in each feature processing sub-network performs self-attention processing on an image sub-feature and a reference key point sub-feature, and
wherein a remaining feature processing layer in each feature processing sub-network performs cross-attention processing on the reference key point sub-feature using a linearly transformed image sub-feature as a value.

11. An image recognition apparatus, comprising:
at least one memory configured to store program code; and
at least one processor configured to read the program code and operate as instructed by the program code, the program code comprising:
extracting code configured to cause at least one of the at least one processor to extract image features from an image to be recognized, the image to be recognized displaying an object to be recognized;
processing code configured to cause at least one of the at least one processor to perform, via a feature processing network, feature processing on the image features and reference key point features obtained through initialization to obtain final key point features of the object to be recognized, the final key point features indicating features of key points of the object to be recognized in the image to be recognized; and
determining code configured to cause at least one of the at least one processor to determine positions of the key points of the object to be recognized in the image to be recognized based on the final key point features,
wherein the feature processing network is obtained by performing N cycles of feature processing on each sample image using an initialized feature processing network, wherein an i^{th} cycle of feature processing comprises:
performing, via an i^{th} feature processing network, feature processing on an (i−1)^{th} sample feature pair obtained from an (i−1)^{th} cycle of feature processing to obtain an i^{th} sample feature pair; and
adjusting network parameters of the i^{th} feature processing network based on feature differences between the (i−1)^{th} sample feature pair and the i^{th} sample feature pair until a convergence condition is reached,
wherein i is an integer from 1 to N, and Nis a positive integer,
wherein the i^{th} sample feature pair comprises i^{th} sample image features and i^{th} reference sample key point features,
wherein the i^{th} sample image features are obtained by performing i cycles of feature processing on original sample image features extracted from the sample images, and
wherein the i^{th} reference sample key point features are obtained by performing i cycles of feature processing on original reference sample key point features obtained through initialization.

12. The apparatus according to claim 11, wherein the feature processing network comprises P feature processing sub-networks, wherein P is a positive integer, and wherein the processing code is further configured to cause at least one of the at least one processor to:
perform the following operations in the feature processing network:
input a (j−1)^{th} image feature and a (j−1)^{th} reference key point feature output by a (j−1)^{th} feature processing sub-network to a j^{th} feature processing sub-network, wherein j is an integer greater than 1 and less than or equal to P;
perform feature processing on the (j−1)^{th} image feature and the (j−1)^{th} reference key point feature in the j^{th} feature processing sub-network to obtain a j^{th} image feature and a j^{th} reference key point feature;
based on j being equal to P, determine the j^{th} reference key point feature as the final key point feature; and
based on j being less than P, input the j^{th} image feature and the j^{th} reference key point feature into a (j+1)^{th} feature processing sub-network to perform a (j+1)^{th} cycle of feature processing.

13. The apparatus according to claim 12, wherein the processing code is further configured to cause at least one of the at least one processor to:
perform the following operations in the j^{th} feature processing sub-network:
in a first feature processing layer of the j^{th} feature processing sub-network, perform linear transformation processing on an image sub-feature output by the (j−1)^{th} feature processing sub-network to obtain a first image sub-feature; and perform linear transformation processing on a
in an h^{th} feature processing layer of the j^{th} feature processing sub-network, input an (h−1)^{th} image sub-feature and an (h−1)^{th} reference key point sub-feature output by an (h−1)^{th} feature processing layer to the h^{th} feature processing layer, wherein h is an integer greater than or equal to 2;
in the h^{th} feature processing layer, perform linear transformation processing on the (h−1)^{th} image sub-feature to obtain a first processing result, and determine the first processing result as the h^{th} image sub-feature output by the h^{th} feature processing layer; perform linear transformation processing on the (h−1)^{th} reference key point sub-feature to obtain a second processing result; and obtain an h^{th} reference key point sub-feature output by the h^{th} feature processing layer based on the first processing result and the second processing result; and
based on the h^{th} feature processing layer being the last feature processing layer in the j^{th} feature processing sub-network, determine the h^{th} image sub-feature as the j^{th} image feature output by the j^{th} feature processing sub-network, and determine the h^{th} reference key point sub-feature as the j^{th} reference key point feature output by the j^{th} feature processing sub-network.

14. The apparatus according to claim 11, wherein the program code further comprises:
training code configured to cause at least one of the at least one processor to train the initialized feature processing network through the following operations:
extract original sample image features from a k^{th} sample image, and obtain original reference sample key point features through initialization, wherein k is an integer from 1 to M, and M is a positive integer; and
repeatedly perform the following operations on the original sample image features and the original reference sample key point features until N cycles of feature processing are performed:
perform, via the i^{th} feature processing network for the i^{th} cycle of feature processing, feature processing on the (i−1)^{th} sample feature pair obtained from the (i−1)^{th} cycle of feature processing to obtain the i^{th} sample feature pair, the (i−1)^{th} sample feature pair being the original
determine a sample feature distance between the (i−1)^{th} sample feature pair and the i^{th} sample feature pair based on feature differences between the (i−1)^{th} sample feature pair and the i^{th} sample feature pair;
perform weighted summation calculation on the first i sample feature distances to obtain an i^{th} feature training loss;
based on the i^{th} feature training loss not reaching a threshold condition, adjust network parameters of the i^{th} feature processing network to obtain an (i+1)^{th} feature processing network, and perform the (i+1)^{th} cycle of feature processing in the (i+1)^{th} feature processing network; and
based on the i^{th} feature training loss reaching the threshold condition, determine the i^{th} cycle of feature processing as the N^{th} cycle of feature processing.

15. The apparatus according to claim 14, wherein the training code is further configured to cause at least one of the at least one processor to:
calculate a distance between an (i−1)^{th} sample image feature in the (i−1)^{th} sample feature pair and an i^{th} sample image feature in the i^{th} sample feature pair to obtain an (i−1)^{th} sample image feature distance; and
calculate a distance between an (i−1)^{th} reference sample key point feature in the (i−1)^{th} sample feature pair and an i^{th} reference sample key point feature in the i^{th} sample feature pair to obtain an (i−1)^{th} reference sample key point feature distance, wherein the sample feature distance comprises the (i−1)^{th} sample image feature distance and the (i−1)^{th} reference sample key point feature distance.

16. The apparatus according to claim 15, wherein the training code is further configured to cause at least one of the at least one processor to:
perform weighted summation calculation on the first i sample image feature distances to obtain a sample image feature training loss, and perform weighted summation calculation on the first i reference sample key point feature distances to obtain a reference key point feature training loss; and
perform weighted summation calculation on the sample image feature training loss and the reference key point feature training loss to obtain the i^{th} feature training loss.

17. The apparatus according to claim 14, wherein the training code is further configured to cause at least one of the at least one processor to:
input the i^{th} reference sample key point feature in the i^{th} sample feature pair to an i^{th} fully-connected layer to obtain an i^{th} key point prediction position;
compare the i^{th} key point prediction position with a key point mark position in the k^{th} sample image to obtain an i^{th} key point prediction difference distance;
perform weighted summation calculation on the first i key point prediction difference distances to obtain an i^{th} key point prediction training loss;
perform weighted summation calculation on the i^{th} feature training loss and the i^{th} key point prediction training loss to obtain an i^{th} target loss;
based on the i^{th} target loss not reaching the threshold condition, adjust network parameters in the i^{th} feature processing network and the i^{th} fully-connected layer to obtain an (i+1)^{th} feature processing network and an (i+1)^{th} fully-connected layer, perform an (i+1)^{th} cycle of feature processing in the (i+1)^{th} feature processing network, and obtain an (i+1)^{th} key point prediction position in the (i+1)^{th} fully-connected layer; and
based on the i^{th} target loss reaching the threshold condition, determine the i^{th} cycle of feature processing as the N^{th} cycle of feature processing.

18. The apparatus according to claim 11, wherein the extracting code is further configured to cause at least one of the at least one processor to:
perform recognition processing on the image to be recognized using a region recognition network to determine a candidate region in which the object to be recognized is located in the image to be recognized;
crop the image to be recognized to reserve the candidate region;
extract image features corresponding to an image content displayed in the candidate region using a feature extraction network;
adjust a feature dimension of the image features to a preset dimension to obtain adjusted image features; and
perform position encoding processing on the adjusted image features to obtain image visual tokens, the image visual tokens being determined as the image features.

19. The apparatus according to claim 11, wherein the determining code is further configured to cause at least one of the at least one processor to:
perform mapping processing on the final key point features using a fully-connected layer connected to the feature processing network to obtain the positions of the key points of the object to be recognized in the image to be recognized.

20. A non-transitory computer-readable storage medium, storing computer code which, when executed by at least one processor, causes the at least one processor to at least:
extract image features from an image to be recognized, the image to be recognized displaying an object to be recognized;
perform, via a feature processing network, feature processing on the image features and reference key point features obtained through initialization to obtain final key point features of the object to be recognized, the final key point features indicating features of key points of the object to be recognized in the image to be recognized; and
determine positions of the key points of the object to be recognized in the image to be recognized based on the final key point features,
wherein the feature processing network is obtained by performing N cycles of feature processing on each sample image using an initialized feature processing network, wherein an i^{th} cycle of feature processing comprises:
performing, via an i^{th} feature processing network, feature processing on an (i−1)^{th} sample feature pair obtained from an (i−1)^{th} cycle of feature processing to obtain an i^{th} sample feature pair; and
adjusting network parameters of the i^{th} feature processing network based on feature differences between the (i−1)^{th} sample feature pair and the i^{th} sample feature pair until a convergence condition is reached,
wherein i is an integer from 1 to N, and N is a positive integer,
wherein the i^{th} sample feature pair comprises i^{th} sample image features and i^{th} reference sample key point features,
wherein the i^{th} sample image features are obtained by performing i cycles of feature processing on original sample image features extracted from the sample images, and
wherein the i^{th} reference sample key point features are obtained by performing i cycles of feature processing on original reference sample key point features obtained through initialization.
